(19) United States
(12) Patent Application Publication
(10) Pub. No.: US 2023/0305615 A1
(43) Pub. Date: Sep. 28, 2023

(54) OPPORTUNISTIC BATTERY CHARGING WITH A PROGRAMMABLE POWER ADAPTER

(71) Applicant: Intel Corporation, Santa Clara, CA (US)

(72) Inventors: Udaya Natarajan, El Dorado Hills, CA (US); Kannappan Rajaraman, Bangalore (IN)

(73) Assignee: Intel Corporation, Santa Clara, CA (US)

(21) Appl. No.: 17/705,012

(22) Filed: Mar. 25, 2022

(51) Int. Cl. G06F 1/3212; H02J 50/80; G06F 13/42; H02J 7/00

(52) U.S. Cl. CPC G06F 1/3212; H02J 50/80; G06F 13/4282; H02J 7/0049; H02J 7/00034

(57) ABSTRACT

Techniques and mechanisms for opportunistically charging a battery with a programmable power adapter. In an embodiment, a charger circuit is to be coupled between the programmable power adapter and a load circuit which is coupled to the battery. Bypass circuitry is coupled to selectively enable a bypassing of the charger circuit. Based on a state of charge of the battery, a controller circuit identifies a power delivery scheme which includes both an operational mode of the programmable power adapter, and an activation state of the switch circuit. The controller configures the identified power delivery scheme by signaling that the programmable power adapter is to be transitioned to the operational mode. In another embodiment, the operational mode is based on communications which are compatible with a Universal Serial Bus (USB) standard protocol.

### BACKGROUND

### 1. Technical Field

This disclosure generally relates to power delivery systems and more particularly, but not exclusively, to the control of power delivery with a programmable power adapter.

### 2. Background Art

Today, many devices charge or get their power from universal serial bus (USB) ports contained in laptops, cars, aircraft, or even wall sockets. USB has become a ubiquitous power socket for many small devices such as cell phones, MP3 players and other hand-held devices. Users often rely on USB to fulfill their requirements not only in terms of data but also to provide power to, or charge, their devices simply, often without the need to load a driver, in order to carry out “traditional” USB functions.

Various types of electronic devices utilize a charger (or charging system) in order to provide power. One type of charger is a USB charger. There are many different types of USB chargers and different type of protocols. The Universal Serial Bus (USB) Revision 3.1 Power Delivery (USB-PD) Specification Revision 2.0 V1.1 of May 7, 2015 supports a data interface between a power adapter which includes a programmable power supply, and a sink device which is to receive power via that power adapter.

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a power delivery system which facilitates operation with a variable power source according to an embodiment.

FIG. 2 shows a flow diagram illustrating features of a method for determining a delivery of power which is provided with a variable power source according to an embodiment.

FIGS. 3A, 3B shows functional block diagrams each illustrating respective features of a power delivery (PD) architecture according to an embodiment.

FIG. 4A shows top and bottom views of a USB Type-C Plug Paddle Card which is configured to facilitate an adjustable supply of power according to an embodiment.

FIG. 4B shows a USB Type-C receptacle interface (front view) which is configured to receive power from an adjustable power supply according to an embodiment.

FIG. 5 shows a timing diagram illustrating features of operations with battery charger circuit according to an embodiment.

FIG. 6 shows a swim-lane diagram illustrating communications performed with a power delivery controller and a programmable power supply according to an embodiment.

FIG. 7 shows a flow diagram illustrating features of a method for determining a delivery of power which is provided with a variable power source according to an embodiment.

FIG. 8 shows a functional block diagram illustrating features of a USB power delivery system to use an adjustable power source in a wireless charging environment according to an embodiment.

FIG. 9 shows a functional block diagram illustrating features of a computing device to determine a delivery of power with a programmable power adapter according to an embodiment.

### DETAILED DESCRIPTION

Embodiments discussed herein variously provide techniques and mechanisms for opportunistically charging a battery with a programmable power adapter. Some embodiments variously facilitate opportunistic charging of a battery using both a selected operational mode of a programmable power adapter (or simply “adapter” herein), and a selected state of circuitry (variously referred to herein as “bypass circuitry,” or “pass through circuitry,” for example) which is coupled to selectively enable—or disable—the bypassing of a charger circuit, such as a buck-boost charger. In this context, “opportunistic charging” refers herein to battery charging which is performed based on a determination that a programmable power adapter is available deliver power in an operational mode which supports the charging, but where (for example) the charging is not strictly required according to one or more other power management test conditions.

For example, in an illustrative scenario according to some embodiments, a programmable power adapter is transitioned from a first operational mode to a second operational mode to enable a given instance of opportunistic charging—e.g., wherein, in and of itself, a power demand (actual, or predicted) of a load circuit does not require said transition. For example, in one such scenario, a decision to perform opportunistic charging is based at least in part on a determination that the load circuit's power demand is expected to continue to be of a type which the first operational mode could supported.

In some embodiments, opportunistic charging is performed using a constant voltage operational mode of a programmable power adapter. In this context, “constant voltage” refers to a mode wherein an adapter outputs a supply voltage, at a substantially unchanging level, on a supply voltage bus VBUS (e.g., wherein the programmable power supply prevents one or more types of changes to the supply voltage which would otherwise take place in an alternative operational mode of the adapter).

Additionally or alternatively, opportunistic charging is performed using a constant current operational mode of a programmable power adapter. In this context, “constant current” refers to a mode wherein an adapter outputs a current, at a substantially unchanging level, on the supply voltage bus VBUS (e.g., wherein the programmable power supply prevents one or more types of changes to the current which would otherwise take place in an alternative operational mode of the adapter). Such a current is referred to herein as a “supply current.”

Certain features of various embodiments are described herein with reference to a delivery of power with a programmable power adapter and a hardware platform which provide respective hardware interface structures, communications protocol support and/or other such features which are compatible with any of various Universal Serial Bus (USB) standards. However, it is to be appreciated that such description can be extended to additionally or alternatively apply to features which are compatible with any of various other standards that support a negotiation of an operational mode of a programmable power adapter. In various embodiments, an adapter—and a hardware platform which receives power from the adapter—support features which are identified, for example, each in a respective one of the Universal Serial Bus Type-C Cable and Connector Specification, Release 2.0, released August, 2019 by the Universal Serial Bus Implementers Forum (USB-IF) of Beaverton, OR, USA, the USB Power Delivery Specification, Revision 3.1, Version 1.3, released January 2022 by the USB-IF of Beaverton, OR, USA, or any of various other such specifications.

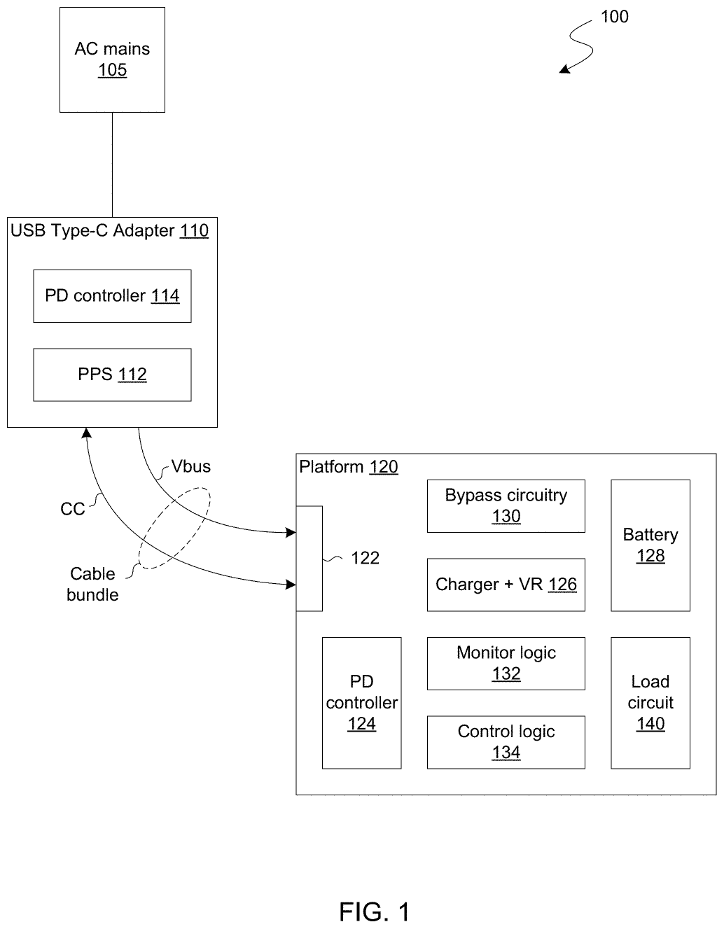

FIG. 1 illustrates a power delivery (PD) system 100 which includes or otherwise operates with a variable power source. In the example embodiment shown, system 100 includes a USB Type-C AC/DC adapter 110 (where AC is alternating current, and DC is direct current) to provide a variable output, and a USB Type-C enabled hardware platform 120. Although some embodiments are not limited in this regard, system 100 further includes, or is to couple to, an alternating current (AC) main receptacle 105 (e.g., a typical wall socket to provide AC voltage and current)

In various embodiments, platform 120 is to function as a power consumer (“consumer” or “sink” herein) while Type-C adapter 110 is to function as a power provider (“provider” or “source” herein). For example, Type-C adapter 110 is coupled to the AC main 105—e.g., via an AC power cord. Type-C adapter 110 comprises a programmable power supply (PPS) 112 which supports any of various modes (referred to herein as “operational modes”) which are each to provide a different respective regulation of power delivery from Type-C adapter 110 to platform 120. Type-C adapter 110 further comprises a PD controller 114 which facilitates the configuration of a given operational mode of PPS 112—e.g., wherein PD controller 114 supports data communications with platform 120 to determine which particular operational mode of PPS 112 is to be configured

In one example embodiment, power is provided to platform 120 through the voltage bus (VBUS) wire(s) of a USB Type-C cable bundle which, for example, connects to platform 120 via a hardware interface 122 thereof (e.g., wherein hardware interface 122 is compatible with a USB Type-C connector standard). A power delivery (PD) controller 124 of platform 120 is coupled to participate in communications with PD controller 114 via the hardware interface 122 and the configuration channel (CC) wire(s) of the cable bundle. PD controller 124 (or, for example, PD controller 114) is implemented with any of various combinations of hardware and/or software which are suitable for supporting communication between Type-C adapter 110 and platform 120. In various embodiments, the cable bundle one or more other wires (not shown), such as one or more sideband channel wires or the like.

In one embodiment, power negotiation messages (e.g., sending a source capabilities list or menu and a selection from that list) between platform 120 and Type-C adapter 110 are performed over the CC wire(s) of the USB Type-C cable bundle. By way of illustration and not limitation, the source capabilities include a vSafe5V (i.e., 5V fixed supply) power data object (PDO) and a variable output PDO—e.g., a variable (non-battery) supply.

Platform 120 illustrates any of various devices (e.g., including a phone, laptop computer, printer, table, desktop computer, or the like) that includes or otherwise supports a load circuit 140 which uses power provided from Type-C adapter 110 via hardware interface 122. Platform 120 includes a regulation module 126 which, for example, includes a charger circuit, such as a buck-boost charger circuit, and system voltage regulator VR (e.g., a DC-DC switching regulator). Platform 120 further includes a battery 128 which is available to power load circuit 140, wherein battery is to be variously charged at different times using Type-C adapter 110 and the charger circuit. The regulation module 126 is coupled to receive a supply power via hardware interface 122, and to output a voltage, with which load circuit 140 is to be powered and/or battery 128 is to be charged.

The family of Universal Serial Bus (USB) Power Delivery (PD), Revision 3.x specifications are one example of a published standard for a device to negotiate or otherwise control a delivery of power by an adapter.

The mobile phone industry has pioneered various battery charging solutions which, for example, variously facilitate a transfer of power to a battery of a host—e.g., wherein the transfer is fast and/or mitigates degradation of battery chemistry.

In various embodiments, platform 120—which facilitates a delivery of power to load circuit 140—comprises a hardware interface 122 to couple to Type-C adapter 110, and a PD controller 124 which is to participate in communications with the PD controller 114 of Type-C adapter 110 via the hardware interface 122. The communications are according to any of various standard PD negotiation protocols such as one which is compatible with a USB PD specification. In an embodiment, the adapter 110 provides functionality to operate in any of multiple predefined modes (“operational modes” herein)—e.g., wherein some or all such modes are each to regulate a level of a voltage and/or to regulate a level of a current. By way of illustration and not limitation, various modes of the adapter 110 are each able to support up to a 5 Amps (A) current with the voltage being at a respective one of 5 Volts (V), 9 V, 15 V, or 20 V (e.g., for up to 100 W power delivery). Additionally or alternatively, a mode of the adapter 110 is able to support up to a 3 A current with the voltage being at 20 V, for example.

In an illustrative scenario according to one embodiment, the system VR of regulation module 126 needs to receive an input voltage at any of one or more levels—e.g., including one of 4.2 V, 8.4 V, or 12.6 V for various respective battery configurations. With a voltage provided by one of the adapter 110 or the battery 128, the system VR typically need to provide an output voltage at any of various other regulated levels—e.g., including one of 5 V, 3.3 V, or 1.8 V—to the load circuit 140 (such as that of a system on chip and/or any of various other platform components). Operation of the system VR is facilitated with the charger circuit (such as one which comprises buck-boost charger) to help convert an adapter output voltage to a battery voltage (VBAT), and/or to a system voltage (VSYS).

In many conventional power delivery solutions, operation of such a charger circuit results in significant switching loss which, for example, is directly proportional to a between the respective voltages provided at the adapter and at the battery (or at the system VR). Switching losses in the battery charger (and, for example, similar losses in the system VR) reduce the efficiency of power delivery, and dissipate thermal energy which is particularly noticeable in mobile devices.

To mitigate such losses, some embodiments further provide bypass circuitry 130 which enables a mode—variously referred to, for example, as a fast charge mode, a pass-through (PT) mode, or bypass mode—wherein a conductive path is enabled to bypass the charger circuit, and thereby mitigate switch losses. With such bypass circuitry 130, the Type-C (or other programmable) power adapter 110 is able to be switched or otherwise operated to provide a path which more directly delivers the particular tracked voltage to battery 128 (e.g., for charging) and/or to the system VR of regulation module 126.

In an embodiment, adapter 110 supports a constant current (CC) mode, during which current from the adapter 110 to a power sink is relatively stable. In a typical use case, a CC mode coincides with or otherwise supports a relatively high power demand (e.g., including a relatively high system voltage VSYS) of the system VR. When provided to a buck-boost (or other charger) circuit, a CC output by adapter 110 often corresponds to relatively high switching loss and/or thermal dissipation. However, a bypass mode mitigates such switching loss and/or thermal dissipation, in some embodiments.

To facilitate efficient opportunistic charging of battery, platform 120 further comprises monitor logic 132 comprising any of various combinations of hardware, firmware, and/or executing software which is suitable to monitor state of platform 120. In an embodiment, monitor logic 132 includes, is coupled to, or otherwise operates with one or more sensors and/or other hardware which is suitable to detect one or more conditions of battery 128, load circuit 140 and/or other circuitry of platform 120. For example, monitor logic 132 monitors a state of charge of battery—e.g., including an amount of charge stored by battery and/or a rate of change (first order, second order, or the like) of the amount of charge. Additionally or alternatively, monitor logic 132 monitors one or more characteristics of power delivery to load circuit 140, and/or one or more indicia of a power demand by load circuit 140. Although shown as being distinct from load circuit 140, monitor logic 132 is alternatively implemented at least partially in load circuit 140 (and/or in any of various other suitable components of platform 120), in other embodiments

In an illustrative scenario according to one embodiment, monitor logic 132 monitors a power demand of load circuit 140 as indicated, for example, by an Intel® Mobile Voltage Positioning status value (or other similar information) from a power management integrated circuit. Additionally or alternatively, monitor logic 132 monitors a currently-implemented mode of the charger circuit (e.g., one of a buck mode, a boost mode). Additionally or alternatively, monitor logic 132 monitors a currently-implemented activation state of bypass circuitry 130—e.g., wherein some switch circuit of bypass circuitry 130 is in one of an active (closed circuit) state which enables a bypass of the charger circuit, or an inactive (open circuit) state which disables that bypass of the charger circuit. Additionally or alternatively, monitor logic 132 is coupled to monitor active workloads of load circuit 140—e.g., where some or all such workloads are loaded in memory—and/or monitors statistical information indicating power level transitions and/or other performance indicators for load circuit 140.

Based on such monitoring of battery, load circuit 140 and/or other features of platform 120, monitor logic 132 specifies or otherwise indicates to control logic 134 whether a test criteria for opportunistic fast battery charging has been met. For example, monitor logic 132 (or alternatively, control logic 134) includes or otherwise has access to reference information which specifies or otherwise indicates multiple test criteria which each correspond to a different respective scheme for Type-C adapter 110 to deliver power for supplying load circuit 140 and/or for charging battery. In an embodiment, some or all such power delivery schemes includes a respective operational mode of Type-C adapter 110, and a respective activation state of bypass circuitry 130.

Where it is detected that a monitored state of platform 120 satisfies a particular one such test criteria, control logic 134 identifies, and configures, the power delivery scheme which corresponds to said test criteria. For example, control logic 134 signals PD controller 124 to transition Type-C adapter 110 to the corresponding operational mode, and further signal that bypass circuitry 130 is to transition (if necessary) to the corresponding activation state.

One limitation of bypass circuitry 130 providing a path which bypasses a charger circuit is sensitivity to a sudden change in system load, which results in a significant voltage sag or spike. Such a change tends to result in feedback to a power adapter, which would traditionally attempt to adjust to by providing the supply voltage at a level which is based on an updated threshold. In real time applications, this adjusting by an adapter tends to remain unsettled—e.g., due to continuously varying power demands of changing system workloads. These conditions are exacerbated, for example, when a relatively large system power demand is supported using a CC mode of the adapter.

By contrast, some embodiments avoid or otherwise mitigate such instability of programmable power adapter 110 during opportunistic charging of battery. For example, such embodiments variously signal that Type-C adapter 110 is to operate in a constant current mode during an activation state of bypass circuitry 130 which enables at least some bypass of the charger circuit in regulation module 126.

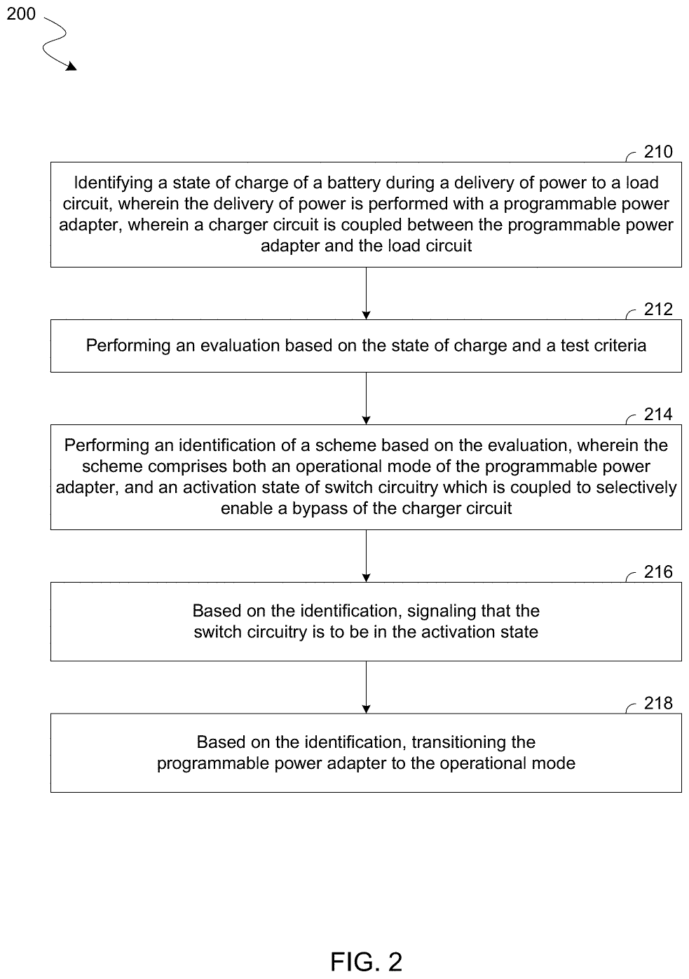

FIG. 2 shows features of a method 200 to provide fast opportunistic battery charging according to an embodiment. Method 200 illustrates one example of an embodiment wherein a power delivery scheme is determined based on a state of charge of a battery, wherein the power delivery scheme includes both an operational state of a programmable power adapter, and an activation state of bypass circuitry which is available to selectively bypass a charger circuit to mitigate switching loss for improved efficiency. In various embodiments, one or more operations of method 200 are performed with monitor logic 132 and/or control logic 134 (for example).

As shown in FIG. 2, method 200 comprises (at 210) identifying a state of charge of a battery during a delivery of power to a load circuit which is coupled to the battery. The delivery of power is performed with a programmable power adapter, wherein a charger circuit is coupled between the programmable power adapter and the load circuit. In an embodiment, bypass circuitry which is coupled to selectively enable a bypass of the charger circuit—e.g., wherein the programmable power adapter, the load circuit, the charger circuit, and the bypass circuitry are Type-C adapter 110, load circuit 140, the charger of regulation module 126, and bypass circuitry 130 (for example).

Method 200 further comprises (at 212) performing an evaluation based on the state of charge and a test criteria. By way of illustration and not limitation, one or more evaluations are performed at 212, where each such evaluation is to determine whether a detected level of charge of the battery is above (for example, at or above) a respective threshold level of charge. In some embodiments, the evaluation performed at 212 is further to determine whether (for example) the load circuit is in a particular power state—e.g., one of an idle power state, a standby power state or the like. Additionally or alternatively, the evaluation performed at 212 is further to determine whether (for example) a workload of the load circuit is above some threshold level.

Method 200 further comprises (at 214) performing an identification of a power delivery scheme based on the evaluation, wherein the power delivery scheme comprises both an operational mode of the programmable power adapter, and an activation state of the bypass circuitry. Based on the performing at 214, method 200 (at 216) signals that the bypass circuitry is to be in the activation state. Furthermore, on the performing at 214, method 200 (at 218) also transitions the programmable power adapter to the operational mode for the power delivery scheme.

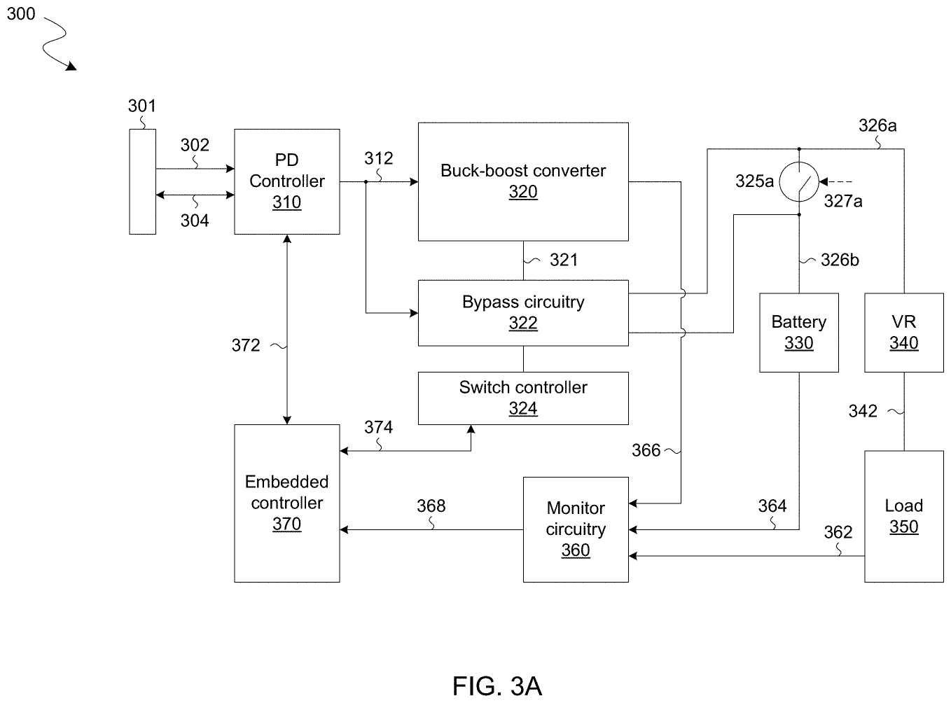

FIG. 3A illustrates features of a device 300 to perform opportunistic battery charging, according to an embodiment, based on power which is received from a programmable power adapter. Device 300 illustrates one example embodiment which includes control circuitry that is operable to determine any of multiple power delivery schemes which each include both a respective operational mode of a programmable power adapter, and a respective activation state of bypass circuitry which is to selectively enable (or disable) the bypassing of a charger circuit. For example, device 300 is to perform one or more operations of method 200, in one embodiment.

In the example embodiment shown, device 300 comprises a hardware interface 301, a PD controller 310, a battery 330, a load circuit 350, monitor circuitry 360, and embedded controller 370 which—for example—correspond functionally to hardware interface 122, PD controller 124, battery 128, load circuit 140, monitor logic 132, and control logic 134 (respectively). Device 300 further comprises a buck-boost converter 320 and a voltage regulator (VR) 340 which, for example, provide functionality of regulation module 126. A bypass circuit 322 of device 300 is operable (responsive to the switch controller 324 shown) to selectively enable, or disable, a bypassing of buck-boost converter 320—e.g., wherein bypass circuit 322 corresponds functionally to bypass circuitry 130.

Hardware interface 301 facilitates coupling of device 300 to any of various programmable power adapters which (for example) provide functionality such as that of Type-C adapter 110. In an embodiment, hardware interface 301 is a USB Type-C 3.0 adapter. During operation of device 300, PD controller 310 participates in communications 304 with the adapter via hardware interface 301—e.g., wherein communications 304 are to negotiate an operational mode of the adapter. Communications 304 are according to a protocol which is compatible with one that is identified (for example) in a USB PD specification. Based on communications 304, the adapter provides a supply voltage 302, according to the negotiated mode, via hardware interface 301—e.g., wherein voltage 302 is passed by PD controller 310 as voltage 312

In one example scenario, at least some switch circuitry of bypass circuit 322 is configured by switch controller 324 to be in an active (closed circuit) state which results in voltage 312 bypassing buck-boost converter 320, and instead being passed as one or both of the voltages 326a, 326b shown. Additionally or alternatively, at least some switch circuitry of bypass circuit 322 is instead configured by switch controller 324 to be in an inactive (open circuit) state, wherein one or both of voltages 326a, 326b are generated based on both voltage 312 and a buck, boost or other mode of buck-boost converter 320. In the example embodiment shown, voltage 326a is provided to VR 340, and voltage 326b is provided to battery 330. In various embodiments, additional switch circuitry is coupled between battery 330 and VR 340—e.g., including the illustrative switch 325a which is operated with a control signal 327a from switch controller 324.

FIG. 3B shows, in a detail view, one example of circuitry which is provided by device 300 according to an embodiment. FIG. 3B illustrates one example embodiment wherein bypass circuit 322 provides any of multiple different activation states which (at least in part) variously determine, for each of voltages 326a, 326b, whether the voltage is to be generated based on—or alternatively, independent of—operations by buck-boost converter 320.

By way of illustration and not limitation, bypass circuit 322 comprises switch circuits 325b, 325c which are operated by respective control signals 327a, 327c (from switch controller 324, for example). In various embodiments, switch circuit 325b provides a first activation state responsive to control signal 327b, wherein the first activation state enables a first conductive path by which voltage 312 is provided as voltage 326a—e.g., wherein the first conductive path is independent of buck-boost converter 320. Additionally or alternatively, responsive to control signal 327b, switch circuit 325b instead provides (e.g., at some other time) a second activation state which enables a second conductive path by which an output voltage 321, generated with buck-boost converter 320, is provided as voltage 326a.

In one such embodiment, switch circuit 325c provides a third activation state responsive to control signal 327c, wherein the third activation state enables a third conductive path by which voltage 312 is provided as voltage 326b—e.g., wherein the third conductive path is independent of buck-boost converter 320. Additionally or alternatively, responsive to control signal 327c, switch circuit 325c instead provides (e.g., at some other time) a fourth activation state which enables a fourth conductive path by which output voltage 321 is provided as voltage 326b. In supporting operation to provide various activation states at different times, bypass circuit 322 enables a selective provisioning of power to load circuit 350—e.g., wherein such provisioning is concurrent with, but independent of, a selective charging of battery 330.

Based on voltage 326a, VR 340 generates a regulated voltage 342 to deliver power to load circuit 350. During such power delivery, monitor circuitry 360 collects and evaluates one or more indicia of system state—e.g., wherein the indicia specifies or otherwise indicates a state of charge of battery 330, a power demand (actual or expected) of load circuit 350, and/or the like. By way of illustration and not limitation, monitor circuitry 360 is coupled to receive a signal 362 which identifies an actual or expected power state of load circuit 350. Alternatively or in addition, signal 362 identifies a total workload of some or all of load circuit 350. Furthermore, monitor circuitry 360 is coupled to receive a signal 364 which identifies a state of charge of battery 330—e.g., wherein the state of charge comprises a level of charge (as a percentage of total charge capacity, for example), a current output by battery 330, and/or the like. In some embodiments, monitor circuitry 360 is further coupled to receive indicia of one or more other components of device 300—e.g., including a signal 366 which indicates a current mode (e.g., a buck mode, or a boost mode) of buck-boost converter 320.

Based such monitoring, monitor circuitry 360 performs an evaluation to determine whether the monitored state of device 300 satisfies some predetermined test criteria for a particular power delivery scheme. In one such embodiment, monitor circuitry 360 sends to embedded controller 370 a signal 368 which specifies or otherwise indicates the test criteria (if any) which has been satisfied. Based on signal 368, embedded controller 370 identifies the corresponding power delivery scheme, and provides communications to configure said scheme. By way of illustration and not limitation, embedded controller 370 participates in communications 372 to indicate to PD controller 310 that the programmable power adapter needs to be transitioned to a different operational mode for the power delivery scheme. In some embodiments, embedded controller 370 participates in additional communications 374 to indicate to switch controller 324 that at least some switch circuitry of the bypass circuit 322 needs to be in a particular activation state (i.e., a particular one of an active state or an inactive state) for the power delivery scheme.

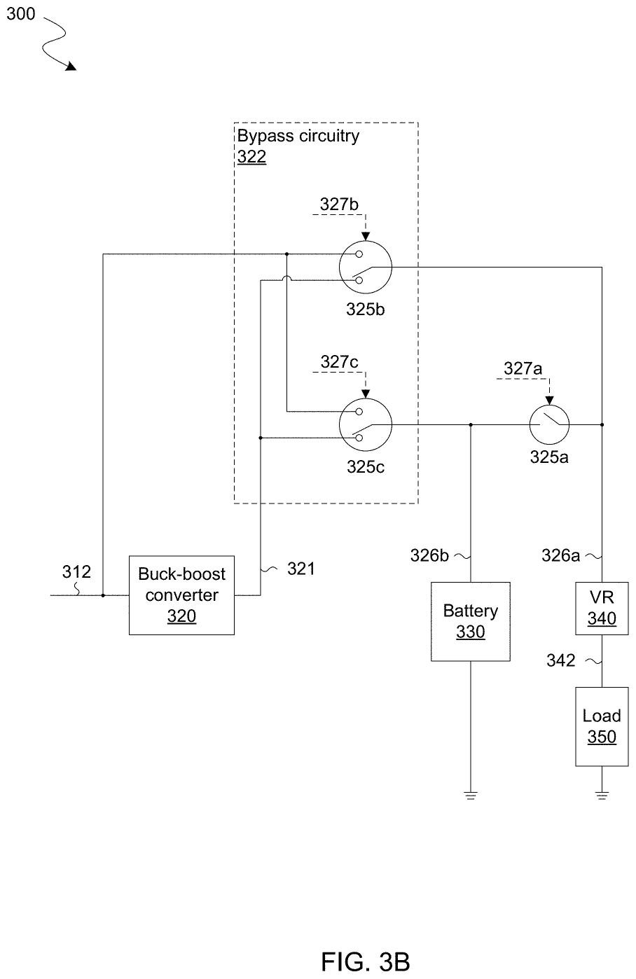

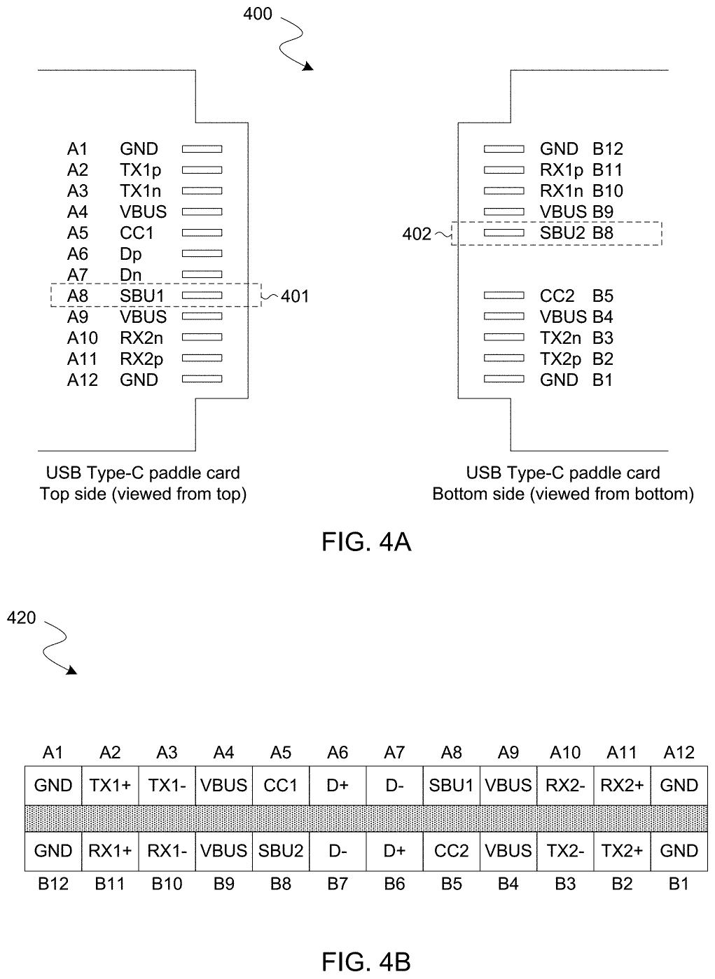

FIG. 4A illustrates top and bottom views 400, respectively, of a USB Type-C plug paddle card which is configured to provide adjustable power supply to a power consumer, according to some embodiments. FIG. 4B illustrates USB Type-C receptacle interface (front view) 420 which is configured to receive adjustable power supply from a power provider, according to some embodiments of the disclosure. The signal list functionally delivers both USB 2.0 (D+ and D−) and USB 3.1 (TX and RX pairs) data buses, USB power (VBUS) and ground (GND), configuration channel signals (CC1 and CC2), and two sideband use (SBU) signal pins (SBU1 401 and SBU2 402). Multiple sets of USB data bus signal locations in this layout facilitate being able to functionally map the USB signals independent of plug orientation in the receptacle.

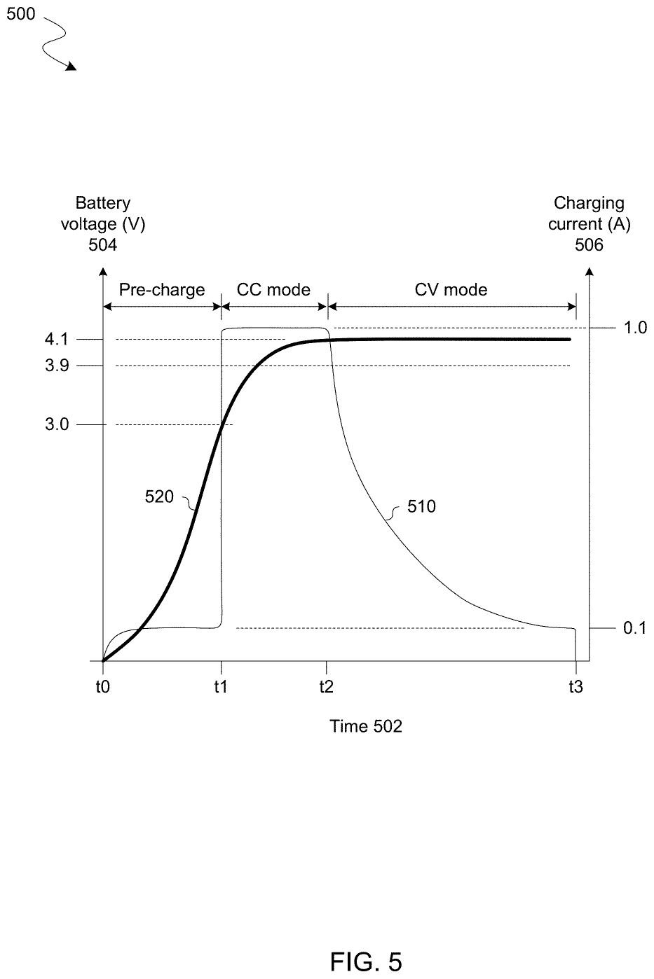

FIG. 5 shows a timing diagram 500 which illustrates a typical practice for battery charging (e.g., with a lithium ion battery) over a period of time 502 according to an embodiment. Timing diagram 500 illustrates characteristics of opportunistic battery charging which is provided with a programmable power supply in some embodiments. For example, such charging is performed with circuitry of system 100 or of device 300—e.g., wherein operations of method 200 include or are otherwise based on such charging.

Timing diagram 500 includes a plot 520 of the level of a battery voltage (VBAT) 504 over time 502. Timing diagram 500 also includes a plot 510 of the level of a current 506 which is used to charge the battery over time 502. As shown in FIG. 5, the period of time from t0 to t1 represents a pre-charge stage during which the level of battery charge is relatively low, wherein a first operational mode of the programmable power adapter supply is provided. In some embodiments, to expedite charging of the battery (e.g., while concurrently supporting a power demand of a load circuit), the first operational mode allows the programmable power adapter to vary the supply voltage which is provided via voltage bus VBUS. Additionally, or alternatively, the first operational mode allows the programmable power adapter to vary the current (“supply current” herein) which is conducted via VBUS. For example, in some embodiments, the first operational mode is provided while a bypass of a buck-boost charger circuit is disabled.

Furthermore, the period of time from t1 to t2 represents a constant current (CC) stage during a second operational mode of the programmable power supply. The second operational mode includes the programmable power supply maintaining the supply current at a substantially constant at a high level (e.g., 1 Amp or as limited by battery chemistry)—e.g., wherein the programmable power supply prevents a type of change to the supply current which would otherwise be allowed according to the first operational mode. In an embodiment, such a CC stage is used to increase the battery charge through an intermediate range, as indicated by the battery voltage approaching a limit (which, in this example scenario, is 4.1 V or other as determined by serial/parallel configuration of battery cells and/or by cell chemistry).

Further still, the period of time from t2 to t3 represents a constant voltage (CV) stage during a third operational mode of the programmable power supply. The third operational mode includes the programmable power supply maintaining the supply voltage at a substantially constant at a high level (e.g., 4.1V)—e.g., wherein the programmable power supply prevents a type of change to the supply voltage which would otherwise be allowed according to the first operational mode (or, for example, according to the second operational mode). In an embodiment, such a CV stage is used to bring the battery to at or near its full charge capacity—e.g., as the rate of charging slows with the decreasing charge current.

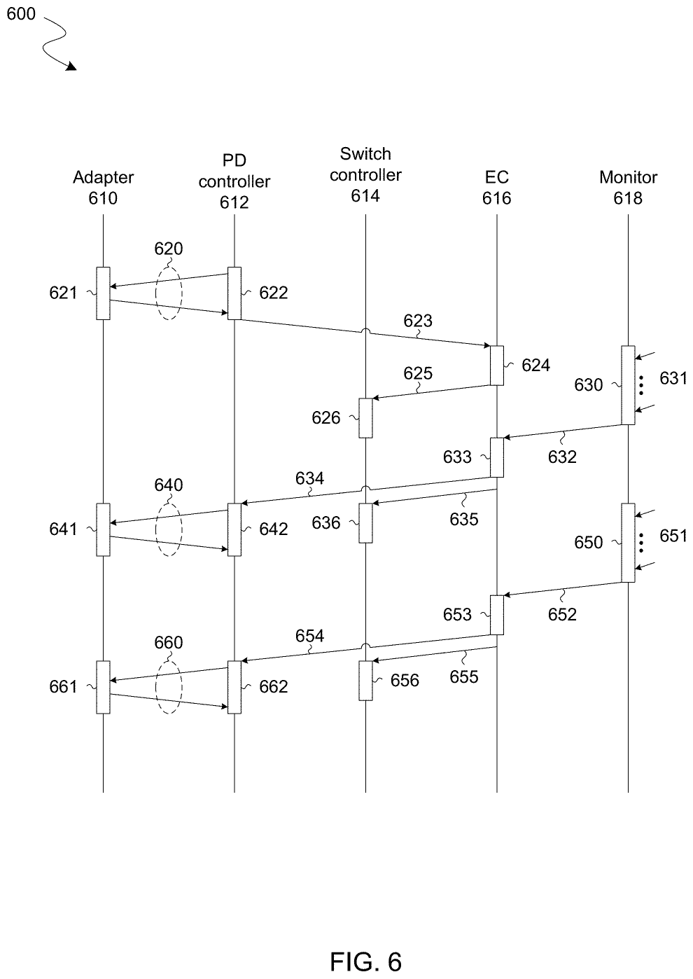

FIG. 6 shows a swim-lane diagram 600 which illustrates various communications and other operations which are to facilitate opportunistic battery charging according to an embodiment. The communications and other operations shown in swim-lane diagram 600 are performed, for example, with circuitry of system 100 or of device 300—e.g., wherein method 200 includes or is otherwise based on some or all such communications and operations.

As shown in FIG. 6, swim-lane diagram 600 shows various communications by a programmable power adapter 610, a power delivery (PD) controller 612, a switch controller 614, an embedded controller (EC) 616, and a monitor 618 which—for example—correspond functionally to adapter 110, PD controller 310, switch controller 324, embedded controller 370, and monitor circuitry 360 (respectively). Based on such communications, some embodiments determine a scheme for delivering power, using adapter 610, to a load circuit which is coupled to a battery, wherein a charger circuit is coupled to provide a voltage to power the load circuit and/or to charge to the battery, and wherein—responsive to switch controller 614—bypass circuitry is to selectively enable (or disable) a conductive path which bypasses the charger circuit.

In the illustrative embodiment shown, adapter 610 and PD controller 612 perform respective control operations 621, 622—and participate in communications 620—to negotiate the configuration of a first operational mode of adapter 610. Based on such negotiations, PD controller 612 communicates a signal 623 which specifies or otherwise indicates the first operational mode—e.g., wherein signal 623 identifies to EC 616 one or more characteristics of the first operational mode.

Based on signal 623, EC 616 performs operations 624 to determine a first activation state (i.e., including a first one of an active state or an inactive state) of at least some switch circuit(s) of the bypass circuitry. In some embodiments, operations 624 are further based on a state of charge of the battery, a power demand of the load circuit, and/or other state of a platform which includes the battery and the load circuit. Based on operations 624, EC 616 communicates a signal 625 which identifies the first activation state—e.g., wherein, based on signal 625, switch controller 614 performs operations 626 which (if necessary) change the bypass circuitry to the identified first activation state. As a result, a first power delivery scheme—comprising the first operational mode and the first activation state—is configured after operations 626 have completed.

At some point during a delivery of power according to the first power delivery scheme, monitor 618 performs operations 630 to receive (and, for example, evaluate) one or more sensor messages 631 which indicate a state of charge of the battery, a power demand by the load circuit, and/or any of various other characteristics of system power state. Based on operations 630, monitor 618 communicates to EC 616 a signal 632 which indicates to EC 616 whether some predetermined test criteria is satisfied by the detected system state—e.g., wherein the test criteria corresponds to a particular power delivery scheme. For example, signal 632 specifies or otherwise indicates indicates whether an amount of charge of the battery is currently within a particular range of charge amounts. Additionally or alternatively, signal 632 indicates whether (or not) the load circuit is currently in a particular system power state—e.g., including one of a standby state, an idle state, or the like.

Based on signal 632, EC 616 performs operations 633 to select or otherwise identify a next power delivery scheme to be implemented with adapter 610 and the bypass circuitry. For example, operations 633 identify a second PD scheme which comprises both a second operational mode of adapter 610, and a second activation state (e.g., a second one of the active state or the inactive state) of the bypass circuitry. Based on operations 633, EC 616 communicates a signal 634 which specifies or otherwise indicates the second operational mode to PD controller 612. Furthermore, EC 616 also communicates another signal 635 based on operations 633, wherein signal 635 indicates to switch controller 614 that the bypass circuitry is to be transitioned to the second activation state (if it is different than the first activation state). In some embodiments, EC 616 further communicates one or more control signals (not shown) to provide a particular one of buck charging or boost charging, for example, with the charger circuit.

Based on signal 634, adapter 610 and PD controller 612 perform respective control operations 641, 642—and participate in communications 640—to negotiate the configuration of the second operational mode of adapter 610. Furthermore, based on signal 635, switch controller 614 performs operations 636 which (if necessary) change the bypass circuitry to the identified second activation state. As a result, the second power delivery scheme is configured after operations 626, 641, 642 have completed.

At some point during a delivery of power according to the second power delivery scheme, monitor 618 performs operations 650 which detect—based on one or more sensor messages 651—a state of charge of the battery and/or other such characteristics of system power state. Based on operations 650, monitor 618 communicates to EC 616 a signal 652 which indicates to EC 616 whether a predetermined test criteria is satisfied by the detected system power state.

Based on signal 652, EC 616 performs operations 653 to select or otherwise identify a next power delivery scheme to be implemented with adapter 610 and the bypass circuitry. For example, operations 653 identify a third PD scheme which comprises both a third operational mode of adapter 610, and a third activation state (e.g., a third one of the active state or the inactive state) of the bypass circuitry. Based on operations 653, EC 616 communicates a signal 654 which specifies or otherwise indicates the third operational mode to PD controller 612. Furthermore, EC 616 also communicates another signal 655 based on operations 653, wherein signal 655 indicates to switch controller 614 that the bypass circuitry is to be transitioned to the third activation state (if it is different than the second activation state). In some embodiments, EC 616 further communicates one or more control signals (not shown) to provide a particular one of buck charging or boost charging, for example, with the charger circuit.

Based on signal 654, adapter 610 and PD controller 612 perform respective control operations 661, 662—and participate in communications 660—to negotiate the configuration of the third operational mode of adapter 610. Furthermore, based on signal 655, switch controller 614 performs operations 656 which (if necessary) change the bypass circuitry to the identified third activation state. As a result, the third power delivery scheme is configured after operations 626, 641, 642 have completed.

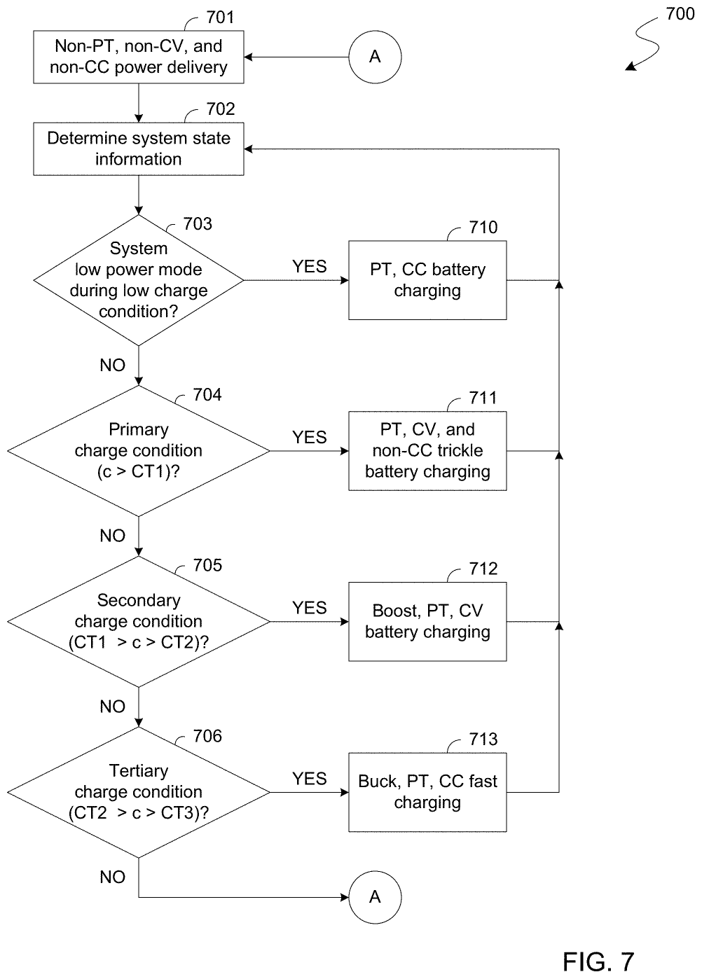

FIG. 7 shows operations of a method 700 to determine a power delivery (PD) scheme for opportunistically charging a battery while meeting a power demand of a load circuit according to an embodiment. Method 700 illustrates one example embodiment wherein multiple evaluations are performed, based on a state of charge of a battery, to select one of multiple PD schemes which each comprise a respective operational mode of a programmable power adapter, and a respective activation state of bypass circuit which is able to selectively bypass a charger circuit. Method 700 is performed with circuitry of platform 120 or device 300, in some embodiments—e.g., wherein method 700 includes operations of method 200 (for example).

In various embodiments, method 700 is performed to facilitate power delivery, using a programmable power adapter, to a load circuit which is coupled to a battery, wherein a charger circuit is coupled to provide a voltage to power the load circuit and/or to charge to the battery, and wherein bypass circuitry is coupled to selectively enable (or disable) a conductive path which bypasses the charger circuit.

For example, method 700 comprises (at 701) configuring a PD scheme wherein the bypass circuitry is inactive—e.g., providing an open circuit state which disables a bypass of the charger circuit—while the programmable power adapter is in a mode which provides a fixed level of power delivery based on “non-CV and non-CC” operation. In an embodiment, the PD scheme provided at 701 allows for switch losses with lower efficiency by the charger circuit, as a tradeoff for relatively quick battery charging. In one example scenario, such quick battery charging takes place at bootup of a system which comprises the load circuit and the battery.

Method 700 further comprises (at 702) determining system state information including (for example) data which specifies or otherwise indicates a state of charge of the battery. Additionally or alternatively, such system state information specifies or otherwise indicates a power state of the load circuit, one or more workloads loaded in memory, and/or other indicia of an actual (or expected future) power demand of the load circuit. In an embodiment, any instance of the determining at 702 is performed during the PD scheme which is most recently configured by method 700.

Based on the system state information determined at 702, method 700 performs one or more evaluations to select one of multiple possible PD schemes that (for example) each include a combination of a respective operational mode of the programmable power adapter, and a respective activation state of the bypass circuitry.

By way of illustration and not limitation, after the determining of system state information at 702, method 700 performs a first evaluation (at 703) to detect for a first condition wherein the load circuit is in a low power state (e.g., a standby mode, an idle mode, or the like)—e.g., where the low power state is concurrent with the battery being below some predetermined threshold state of charge (in one example embodiment, less than 50% of the battery's charge capacity). Where the first evaluation at 703 detects the first condition, method 700 (at 710) communicates one or more signals to configure a first PD scheme wherein the bypass circuitry is in a first activation state during a first operational mode of the programmable power adapter. In the first operational mode, the programmable power adapter is to provide “constant current” (CC) regulation which prevents at least some type of change to the supply current (i.e., the level of the current which is provided on the supply bus VBUS for the supply voltage) which would otherwise take place, for example, during the operational mode at 701. The first activation state bypasses the charger circuit in providing the supply voltage more directly to a battery (e.g., battery 330) and system VR (such as VR 340). After the first PD scheme is configured at 710, method 700 performs a next instance of the determining of system state information at 702.

Where the first evaluation at 703 instead fails to detect the first condition, method 700 performs a second evaluation (at 704) to detect for a second condition wherein an amount of a charge of the battery is above a relatively high threshold CT1, and wherein the programmable power adapter, during a bypass mode, would be able to support an estimated power demand by the load circuit. The first threshold is, for example, a threshold minimum level of charge, above which it is sufficient for the battery to be provided with only occasional (“trickle”) charging, which consumes very low current, while the power demand of the load circuit is concurrently being met. By way of illustration and not limitation, the threshold CT1 is equal to 95% of the battery's charge capacity, in some embodiments.

Where the second evaluation at 704 detects the second condition, method 700 (at 711) configures a second PD scheme wherein the bypass circuitry is in a second activation state during a second operational mode of the programmable power adapter. The second operational mode provides constant current (CC) power delivery while the programmable power adapter is able to program any of various levels for the supply voltage provided by VBUS—e.g., to set the level equal to a desired load circuit voltage for the supply current on VBUS which is requested by the load circuit, and/or for battery trickle charging. This is a high efficiency power transfer from the programmable power source adapter to the load circuit and battery. In an embodiment, the second activation state is the first activation state (for example), or otherwise bypasses the charger circuit in providing the supply voltage more directly to the system VR. After the second PD scheme is configured at 711, method 700 (in some embodiments) performs a next instance of the determining of system state information at 702.

Where the second evaluation at 704 instead fails to detect the second condition, method 700 performs a third evaluation (at 705) to detect for a third condition wherein the amount of the charge is above a threshold CT2 and below the threshold CT1. The second threshold is, for example, another threshold minimum level of charge, above which boost operation of the charger circuit can take place relatively efficiently in combination with constant supply voltage (CV) operation—and varying supply current (non-CC) operation—of the programmable power adapter. By way of illustration and not limitation, the threshold CT2 is in a range from 80% to 85% of the battery's charge capacity, in some embodiments.

Where the third evaluation at 705 detects the third condition, method 700 (at 712) configures a third PD scheme wherein the bypass circuitry is in a third activation state during a third operational mode of the programmable power adapter. The third operational mode comprises constant voltage (CV) operation by the programmable power adapter during a boost mode of the charger circuit. In the third operational mode (e.g., a CV mode), the programmable power adapter programs a level of the supply voltage on VBUS to be equivalent to a load circuit voltage (such as one provided by VR 340)—e.g., wherein the CV mode prevents a type of variation to the supply voltage that would otherwise be allowed (for example) during the operational mode at 701. The third activation state bypasses the charger circuit in providing the supply voltage more directly to the system VR (such as VR 340), while also providing another conductive path which enables boost charging of the battery with the charger circuit. After the third PD scheme is configured at 712, method 700 performs a next instance of the determining of system state information at 702.

Where the third evaluation at 705 instead fails to detect the third condition, method 700 performs a fourth evaluation (at 706) to detect for a fourth condition wherein the amount of the charge of the battery is above a threshold CT3 and below the threshold CT2—e.g., while the adapter is able to meet the power delivery requirements of the load circuit. The third threshold is, for example, another threshold minimum level of charge, above which buck operation of the charger circuit can take place relatively efficiently during a constant supply current (CC) operation. By way of illustration and not limitation, the threshold CT3 is in a range from 50% to 55% of the battery's charge capacity, in some embodiments.

Where the fourth evaluation at 706 detects the fourth condition, method 700 (at 713) signals the configuration of a fourth PD scheme wherein the bypass circuit is in a fourth activation state during a fourth operational mode of the programmable power adapter. In an embodiment, the fourth operational mode comprises a buck mode with constant current (CC) operation by the programmable power adapter. The CC operation prevents at least some type of change to the supply current which would otherwise take place (for example) during the operational mode at 701. The fourth activation state comprises the third activation state (for example), or otherwise bypasses the charger circuit in providing the supply voltage more directly to the system VR, while also providing another conductive path which enables buck charging of the battery with the charger circuit. After the fourth PD scheme is configured at 713, method 700 performs a next instance of the determining of system state information at 702. Where the fourth evaluation at 706 instead fails to detect the fourth condition, method 700 performs a next instance of the power delivery for battery charging at 701.

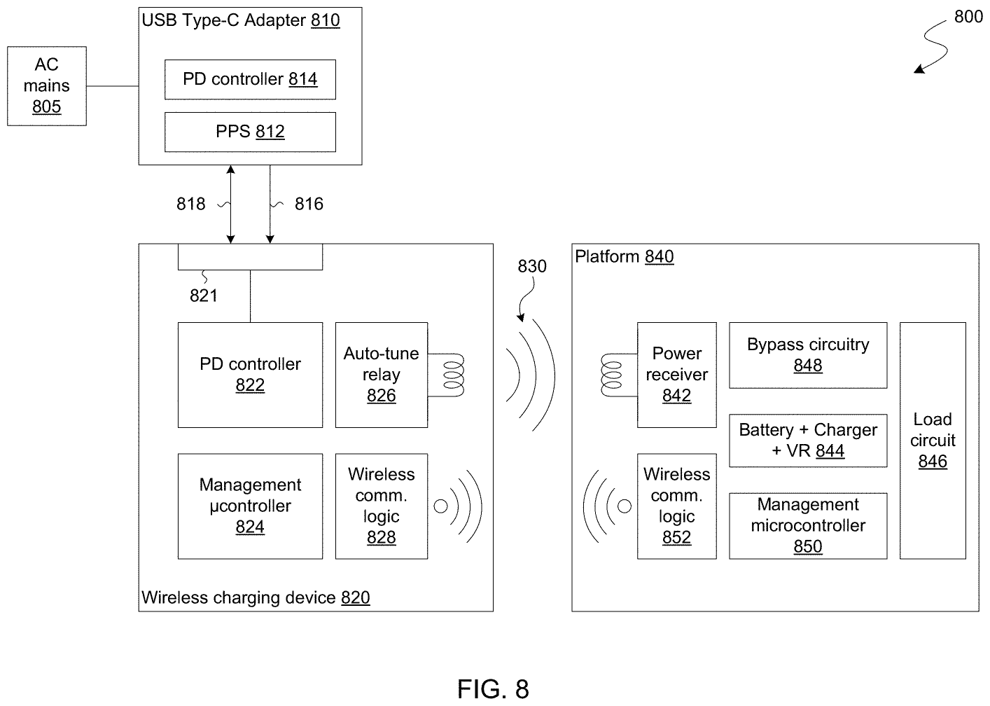

FIG. 8 illustrates a USB power delivery system 800 which supports an adjustable delivery of power in a wireless charging environment, in accordance with an embodiment. System 800 shows one example embodiment wherein a scheme—to facilitate wireless power delivery—is determined based on a state of charge of a battery, and/or a workload or other state of a load circuit which is to receive power with the battery. For example, system 800 includes features of one of system 100, or device 300—e.g., wherein system 800 performs one of method 200 or method 700 (and/or is to participate in communications such as those shown in timing diagram 600).

In the example embodiment shown, system 800 comprises a USB Type-C adapter 810, a wireless charging device 820, and a wireless charging-enabled platform 840. In some embodiments, system 800 further comprises—or alternatively, is to couple to—an AC main 805 (e.g., wherein AC main 805 and USB Type-C adapter 810 correspond functionally to AC main 105 and Type-C adapter 110, respectively).

USB Type-C adapter 810 comprises a PPS 812 and a PD controller 814 which, for example, provide functionality such as that of PPS 112, and PD controller 114 (respectively). In some embodiments, wireless charging device 820 comprises a hardware interface 821, a PD controller 822, an auto-tune relay 826, management microcontroller 824, wireless communication logic 828, and a power transmitter unit (PTU) coil. PD controller 822 supports communications 818 with PD controller 814 to negotiate or otherwise determine an operational mode of adapter 810, wherein PPS 812 is to delivery power using a supply voltage 816 according to said operational mode.

The auto-tune relay 826, together with the PTU coil, sends power 830 wirelessly to the wireless charging-enabled platform 840, in accordance with some embodiments. In various embodiments, wireless charging device 820 comprises additional circuitry to facilitate wireless delivery of power 830. By way of illustration and not limitation, such additional circuitry comprises (for example) a radio frequency power amplifier to convert a low-power signal into a larger signal of significant power—e.g., to facilitate operation of auto-tune relay 826 with the PTU coil. Additionally or alternatively, such additional circuitry provides an output impedance of a signal source to match with the physical impedance characteristics of the PTU coil in order to maximize the power transfer and/or minimize the signal reflection. In some embodiments, auto-tune relay 826 is a switching circuit that automatically adjusts the frequency of a radio transmission. In some embodiments, the PTU coil is a wire winding, typically circular, oval, or rectangular, which acts as the antenna for the transmission of wireless power. In some embodiments, a management microcontroller 824 comprises a microprocessor (e.g., embedded with firmware which is able to execute code) and/or other circuitry which is suitable to manage a power delivery algorithm and, for example, various communications for wireless charging device 820. In some embodiments, wireless communication logic 828 is a kind of radio by which two devices exchange data messages (e.g., power delivery management messages).

In some embodiments, wireless charging-enabled platform 840 comprises a power receiver unit (PRU) coil, a power receiver 842, a voltage regulation module 844 (e.g., comprising a battery, a charger circuit, and a voltage regulator), wireless communication logic 852, management microcontroller 850, and load circuit 846. Platform 840 further comprises bypass circuitry 848 which is operable to selectively enable (or disable) a conductive path which is to bypass the charger of voltage regulation module 844—e.g., to directly provide power to the VR and/or to the battery of voltage regulation module 844.

In various embodiments, the PRU coil receives the power 830 transmitted by the PTU coil of auto-tune relay 826. In one such embodiment, the PRU coil is a wire winding, typically circular, oval, or rectangular, which acts as the antenna for the reception of wireless power. In some embodiments, a battery (e.g., part of voltage regulation module 844) is provided which is a reservoir for the storage of electrical power until later use is required. In some embodiments, a charger circuit (part of voltage regulation module 844) is provided which is an electronic circuit that uses methods for the optimal insertion and storage of electrical charge into the battery. In some embodiments, a voltage regulator (e.g., part of voltage regulation module 844) provides voltage regulation to constrain the delivery of a voltage to load circuit 846 to within a narrow range (for example, +/−5%) even over a wide range of load conditions (for example, the current demands of the load circuit rise and fall dynamically). For example, the input of the voltage regulator is close to the target output voltage (e.g., input=+5V+/−20% and output=+5V+/−5%) or, alternatively, it is a very different voltage (e.g., “buck regulator”: input=+20V+/−20% and output=+5V+/−5%, or “boost regulator”: input=+3.3V+/−10% and output=+9V+/−5%).

In some embodiments, management microcontroller 850 comprises a microprocessor (e.g., embedded with firmware which is able to execute code) and/or other circuitry which is suitable to manage a power delivery algorithm and, for example, various communications for platform 840. In some embodiments, wireless communication logic 852 is provided which is an example of one kind of radio by which two devices exchange data messages (e.g., power delivery management messages).

In various embodiments, wireless charging device 820 provides functionality to determine a scheme for wirelessly delivering power to load circuit 846 and/or to charge the battery in voltage regulation module 844—e.g., wherein the scheme is based on a state of charge of the battery. By way of illustration and not limitation, load circuit 846 and/or management microcontroller 850 include, are coupled to, or otherwise operate based on one or more sensors (not shown), or other suitable circuitry, which is to monitor the state of charge and/or a state of load circuit 846. For example, such circuitry is to monitor an amount of charge of the battery—e.g., as a percentage of the total charge capacity of the battery—and/or a level of a current (if any) which is output by the battery. Additionally or alternatively, such circuitry is to identify or otherwise detect an actual or expected future power state of the load circuit 846, an actual or expected future one or more workloads of the load circuit 846, or the like—e.g., where such detecting is to determine a present, or expected future, power demand by the load circuit 846.

Information which is determined by the monitoring with management microcontroller 850, and/or with load circuit 846, is communicated from platform 840 to management microcontroller 824 via wireless communication logic 852 and wireless communication logic 828. In one such embodiment, management microcontroller 824 performs an evaluation (such as that at 212 in method 200) to detect for an opportunity to charge the battery in voltage regulation module 844 while maintaining a required delivery of power to load circuit 846.

For example, management microcontroller 824 performs one or more of the evaluations of method 700 to identify a first power delivery scheme. By way of illustration and not limitation, management microcontroller 824 performs a selection of the first power delivery scheme from among multiple power delivery schemes which each comprise a respective operational mode of USB Type-C adapter 810 and a respective activation state of bypass circuitry 848. Based on the identification of the power delivery scheme, management microcontroller 824 signals PD controller 822 to participate in communications 818 with USB Type-C adapter 810, where the communications 818 are to signal PD controller 814 to transition PPS 812 to a first operational mode of the identified first power delivery scheme. Additionally, management microcontroller 824 participates in wireless communications with management microcontroller 850—via wireless communication logic 828 and wireless communication logic 852—to indicate that bypass circuitry 848 is to be in a first activation state—e.g., one of an active (closed circuit) state or an inactive (open circuit) state—of the identified first power delivery scheme.

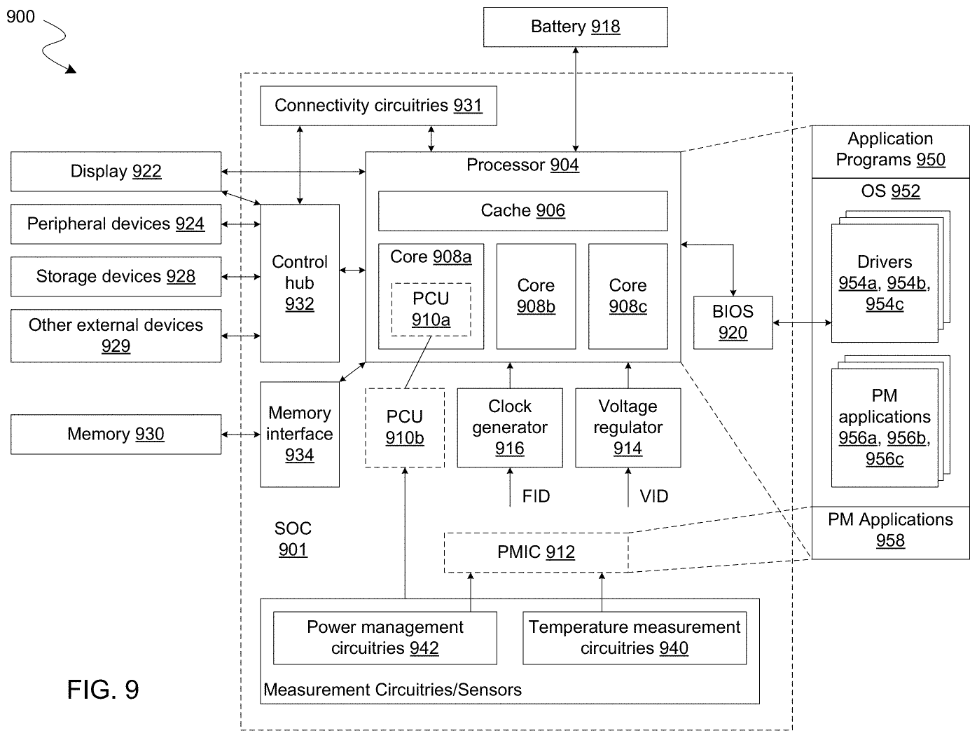

FIG. 9 illustrates a computer system or computing device 900 (also referred to as device 900), where a scheme to deliver power to a load circuit is determined in accordance with some embodiments. It is pointed out that those elements of FIG. 9 having the same reference numbers (or names) as the elements of any other figure can operate or function in any manner similar to that described, but are not limited to such.

In some embodiments, device 900 represents an appropriate computing device, such as a computing tablet, a mobile phone or smart-phone, a laptop, a desktop, an Internet-of-Things (JOT) device, a server, a wearable device, a set-top box, a wireless-enabled e-reader, or the like. It will be understood that certain components are shown generally, and not all components of such a device are shown in device 900.

In an example, the device 900 comprises a SoC (System-on-Chip) 901. An example boundary of the SOC 901 is illustrated using dotted lines in FIG. 9, with some example components being illustrated to be included within SOC 901—however, SOC 901 may include any appropriate components of device 900.

In some embodiments, device 900 includes processor 904. Processor 904 can include one or more physical devices, such as microprocessors, application processors, microcontrollers, programmable logic devices, processing cores, or other processing means. The processing operations performed by processor 904 include the execution of an operating platform or operating system on which applications and/or device functions are executed. The processing operations include operations related to I/O (input/output) with a human user or with other devices, operations related to power management, operations related to connecting computing device 900 to another device, and/or the like. The processing operations may also include operations related to audio I/O and/or display I/O.

In some embodiments, processor 904 includes multiple processing cores (also referred to as cores) 908a, 908b, 908c. Although merely three cores 908a, 908b, 908c are illustrated in FIG. 9, the processor 904 may include any other appropriate number of processing cores, e.g., tens, or even hundreds of processing cores. Processor cores 908a, 908b, 908c may be implemented on a single integrated circuit (IC) chip. Moreover, the chip may include one or more shared and/or private caches, buses or interconnections, graphics and/or memory controllers, or other components.

In some embodiments, processor 904 includes cache 906. In an example, sections of cache 906 may be dedicated to individual cores 908 (e.g., a first section of cache 906 dedicated to core 908a, a second section of cache 906 dedicated to core 908b, and so on). In an example, one or more sections of cache 906 may be shared among two or more of cores 908. Cache 906 may be split in different levels, e.g., level 1 (L1) cache, level 2 (L2) cache, level 3 (L3) cache, etc.

In some embodiments, a given processor core (e.g., core 908a) may include a fetch unit to fetch instructions (including instructions with conditional branches) for execution by the core 908a. The instructions may be fetched from any storage devices such as the memory 930. Processor core 908a may also include a decode unit to decode the fetched instruction. For example, the decode unit may decode the fetched instruction into a plurality of micro-operations. Processor core 908a may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, an execution unit may execute instructions out-of-order. Hence, processor core 908a (for example) may be an out-of-order processor core in one embodiment. Processor core 908a may also include a retirement unit. The retirement unit may retire executed instructions after they are committed. In an embodiment, retirement of the executed instructions may result in processor state being committed from the execution of the instructions, physical registers used by the instructions being de-allocated, etc. The processor core 908a may also include a bus unit to enable communication between components of the processor core 908a and other components via one or more buses. Processor core 908a may also include one or more registers to store data accessed by various components of the core 908a (such as values related to assigned app priorities and/or sub-system states (modes) association.

In some embodiments, device 900 comprises connectivity circuitries 931. For example, connectivity circuitries 931 includes hardware devices (e.g., wireless and/or wired connectors and communication hardware) and/or software components (e.g., drivers, protocol stacks), e.g., to enable device 900 to communicate with external devices. Device 900 may be separate from the external devices, such as other computing devices, wireless access points or base stations, etc.

In an example, connectivity circuitries 931 may include multiple different types of connectivity. To generalize, the connectivity circuitries 931 may include cellular connectivity circuitries, wireless connectivity circuitries, etc. Cellular connectivity circuitries of connectivity circuitries 931 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 931 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 931 may include a network interface, such as a wired or wireless interface, e.g., so that a system embodiment may be incorporated into a wireless device, for example, cell phone or personal digital assistant.

In some embodiments, device 900 comprises control hub 932, which represents hardware devices and/or software components related to interaction with one or more I/O devices. For example, processor 904 may communicate with one or more of display 922, one or more peripheral devices 924, storage devices 928, one or more other external devices 929, etc., via control hub 932. Control hub 932 may be a chipset, a Platform Control Hub (PCH), and/or the like.

For example, control hub 932 illustrates one or more connection points for additional devices that connect to device 900, e.g., through which a user might interact with the system. For example, devices (e.g., devices 929) that can be attached to device 900 include microphone devices, speaker or stereo systems, audio devices, video systems or other display devices, keyboard or keypad devices, or other I/O devices for use with specific applications such as card readers or other devices.

As mentioned above, control hub 932 can interact with audio devices, display 922, etc. For example, input through a microphone or other audio device can provide input or commands for one or more applications or functions of device 900. Additionally, audio output can be provided instead of, or in addition to display output. In another example, if display 922 includes a touch screen, display 922 also acts as an input device, which can be at least partially managed by control hub 932. There can also be additional buttons or switches on computing device 900 to provide I/O functions managed by control hub 932. In one embodiment, control hub 932 manages devices such as accelerometers, cameras, light sensors or other environmental sensors, or other hardware that can be included in device 900. The input can be part of direct user interaction, as well as providing environmental input to the system to influence its operations (such as filtering for noise, adjusting displays for brightness detection, applying a flash for a camera, or other features).

In some embodiments, control hub 932 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 922 represents hardware (e.g., display devices) and software (e.g., drivers) components that provide a visual and/or tactile display for a user to interact with device 900. Display 922 may include a display interface, a display screen, and/or hardware device used to provide a display to a user. In some embodiments, display 922 includes a touch screen (or touch pad) device that provides both output and input to a user. In an example, display 922 may communicate directly with the processor 904. Display 922 can be one or more of an internal display device, as in a mobile electronic device or a laptop device or an external display device attached via a display interface (e.g., DisplayPort, etc.). In one embodiment display 922 can be a head mounted display (HMD) such as a stereoscopic display device for use in virtual reality (VR) applications or augmented reality (AR) applications.

In some embodiments and although not illustrated in the figure, in addition to (or instead of) processor 904, device 900 may include Graphics Processing Unit (GPU) comprising one or more graphics processing cores, which may control one or more aspects of displaying contents on display 922.

Control hub 932 (or platform controller hub) may include hardware interfaces and connectors, as well as software components (e.g., drivers, protocol stacks) to make peripheral connections, e.g., to peripheral devices 924.

It will be understood that device 900 could both be a peripheral device to other computing devices, as well as have peripheral devices connected to it. Device 900 may have a “docking” connector to connect to other computing devices for purposes such as managing (e.g., downloading and/or uploading, changing, synchronizing) content on device 900. Additionally, a docking connector can allow device 900 to connect to certain peripherals that allow computing device 900 to control content output, for example, to audiovisual or other systems.

In addition to a proprietary docking connector or other proprietary connection hardware, device 900 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 931 may be coupled to control hub 932, e.g., in addition to, or instead of, being coupled directly to the processor 904. In some embodiments, display 922 may be coupled to control hub 932, e.g., in addition to, or instead of, being coupled directly to processor 904.

In some embodiments, device 900 comprises memory 930 coupled to processor 904 via memory interface 934. Memory 930 includes memory devices for storing information in device 900. Memory can include nonvolatile (state does not change if power to the memory device is interrupted) and/or volatile (state is indeterminate if power to the memory device is interrupted) memory devices. Memory device 930 can be a dynamic random access memory (DRAM) device, a static random access memory (SRAM) device, flash memory device, phase-change memory device, or some other memory device having suitable performance to serve as process memory. In one embodiment, memory 930 can operate as system memory for device 900, to store data and instructions for use when the one or more processors 904 executes an application or process. Memory 930 can store application data, user data, music, photos, documents, or other data, as well as system data (whether long-term or temporary) related to the execution of the applications and functions of device 900.

Elements of various embodiments and examples are also provided as a machine-readable medium (e.g., memory 930) for storing the computer-executable instructions (e.g., instructions to implement any other processes discussed herein). The machine-readable medium (e.g., memory 930) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 900 comprises temperature measurement circuitries 940, e.g., for measuring temperature of various components of device 900. In an example, temperature measurement circuitries 940 may be embedded, or coupled or attached to various components, whose temperature are to be measured and monitored. For example, temperature measurement circuitries 940 may measure temperature of (or within) one or more of cores 908a, 908b, 908c, voltage regulator 914, memory 930, a mother-board of SOC 901, and/or any appropriate component of device 900.

In some embodiments, device 900 comprises power measurement circuitries 942, e.g., for measuring power consumed by one or more components of the device 900. In an example, in addition to, or instead of, measuring power, the power measurement circuitries 942 may measure voltage and/or current. In an example, the power measurement circuitries 942 may be embedded, or coupled or attached to various components, whose power, voltage, and/or current consumption are to be measured and monitored. For example, power measurement circuitries 942 may measure power, current and/or voltage supplied by one or more voltage regulators 914, power supplied to SOC 901, power supplied to device 900, power consumed by processor 904 (or any other component) of device 900, etc.

In some embodiments, device 900 comprises one or more voltage regulator circuitries, generally referred to as voltage regulator (VR) 914. VR 914 generates signals at appropriate voltage levels, which may be supplied to operate any appropriate components of the device 900. Merely as an example, VR 914 is illustrated to be supplying signals to processor 904 of device 900. In some embodiments, VR 914 receives one or more Voltage Identification (VID) signals, and generates the voltage signal at an appropriate level, based on the VID signals. Various type of VRs may be utilized for the VR 914. For example, VR 914 may include a “buck” VR, “boost” VR, a combination of buck and boost VRs, low dropout (LDO) regulators, switching DC-DC regulators, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR which is controlled by PCU 910a/b and/or PMIC 912. In some embodiments, each core has a network of distributed LDOs to provide efficient control for power management. The LDOs can be digital, analog, or a combination of digital or analog LDOs.

In some embodiments, device 900 comprises one or more clock generator circuitries, generally referred to as clock generator 916. Clock generator 916 generates clock signals at appropriate frequency levels, which may be supplied to any appropriate components of device 900. Merely as an example, clock generator 916 is illustrated to be supplying clock signals to processor 904 of device 900. In some embodiments, clock generator 916 receives one or more Frequency Identification (FID) signals, and generates the clock signals at an appropriate frequency, based on the FID signals.

In some embodiments, device 900 comprises battery 918 supplying power to various components of device 900. Merely as an example, battery 918 is illustrated to be supplying power to processor 904. Although not illustrated in the figures, device 900 may comprise a charging circuitry, e.g., to recharge the battery, based on Alternating Current (AC) power supply received from an AC adapter.

In some embodiments, device 900 comprises Power Control Unit (PCU) 910 (also referred to as Power Management Unit (PMU), Power Controller, etc.). In an example, some sections of PCU 910 may be implemented by one or more processing cores 908, and these sections of PCU 910 are symbolically illustrated using a dotted box and labelled PCU 910a. In an example, some other sections of PCU 910 may be implemented outside the processing cores 908, and these sections of PCU 910 are symbolically illustrated using a dotted box and labelled as PCU 910b. PCU 910 may implement various power management operations for device 900. PCU 910 may include hardware interfaces, hardware circuitries, connectors, registers, etc., as well as software components (e.g., drivers, protocol stacks), to implement various power management operations for device 900.

In some embodiments, device 900 comprises Power Management Integrated Circuit (PMIC) 912, e.g., to implement various power management operations for device 900. In some embodiments, PMIC 912 is a Reconfigurable Power Management ICs (RPMICs) and/or an IMVP (Intel® Mobile Voltage Positioning). In an example, the PMIC is within an IC chip separate from processor 904. The may implement various power management operations for device 900. PMIC 912 may include hardware interfaces, hardware circuitries, connectors, registers, etc., as well as software components (e.g., drivers, protocol stacks), to implement various power management operations for device 900.

In an example, device 900 comprises one or both PCU 910 or PMIC 912. In an example, any one of PCU 910 or PMIC 912 may be absent in device 900, and hence, these components are illustrated using dotted lines.

Various power management operations of device 900 may be performed by PCU 910, by PMIC 912, or by a combination of PCU 910 and PMIC 912. For example, PCU 910 and/or PMIC 912 may select a power state (e.g., P-state) for various components of device 900. For example, PCU 910 and/or PMIC 912 may select a power state (e.g., in accordance with the ACPI (Advanced Configuration and Power Interface) specification) for various components of device 900. Merely as an example, PCU 910 and/or PMIC 912 may cause various components of the device 900 to transition to a sleep state, to an active state, to an appropriate C state (e.g., CO state, or another appropriate C state, in accordance with the ACPI specification), etc. In an example, PCU 910 and/or PMIC 912 may control a voltage output by VR 914 and/or a frequency of a clock signal output by the clock generator, e.g., by outputting the VID signal and/or the FID signal, respectively. In an example, PCU 910 and/or PMIC 912 may control battery power usage, charging of battery 918, and features related to power saving operation.

The clock generator 916 can comprise a phase locked loop (PLL), frequency locked loop (FLL), or any suitable clock source. In some embodiments, each core of processor 904 has its own clock source. As such, each core can operate at a frequency independent of the frequency of operation of the other core. In some embodiments, PCU 910 and/or PMIC 912 performs adaptive or dynamic frequency scaling or adjustment. For example, clock frequency of a processor core can be increased if the core is not operating at its maximum power consumption threshold or limit. In some embodiments, PCU 910 and/or PMIC 912 determines the operating condition of each core of a processor, and opportunistically adjusts frequency and/or power supply voltage of that core without the core clocking source (e.g., PLL of that core) losing lock when the PCU 910 and/or PMIC 912 determines that the core is operating below a target performance level. For example, if a core is drawing current from a power supply rail less than a total current allocated for that core or processor 904, then PCU 910 and/or PMIC 912 can temporarily increase the power draw for that core or processor 904 (e.g., by increasing clock frequency and/or power supply voltage level) so that the core or processor 904 can perform at a higher performance level. As such, voltage and/or frequency can be increased temporality for processor 904 without violating product reliability.

In an example, PCU 910 and/or PMIC 912 may perform power management operations, e.g., based at least in part on receiving measurements from power measurement circuitries 942, temperature measurement circuitries 940, charge level of battery 918, and/or any other appropriate information that may be used for power management. To that end, PMIC 912 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 910 and/or PMIC 912 in at least one embodiment to allow PCU 910 and/or PMIC 912 to manage processor core energy at least in part based on value(s) detected by one or more of the sensors.

Also illustrated is an example software stack of device 900 (although not all elements of the software stack are illustrated). Merely as an example, processors 904 may execute application programs 950, Operating System 952, one or more Power Management (PM) specific application programs (e.g., generically referred to as PM applications 958), and/or the like. PM applications 958 may also be executed by the PCU 910 and/or PMIC 912. OS 952 may also include one or more PM applications 956a, 956b, 956c. The OS 952 may also include various drivers 954a, 954b, 954c, etc., some of which may be specific for power management purposes. In some embodiments, device 900 may further comprise a Basic Input/Output System (BIOS) 920. BIOS 920 may communicate with OS 952 (e.g., via one or more drivers 954), communicate with processors 904, etc.

For example, one or more of PM applications 958, 956, drivers 954, BIOS 920, etc. may be used to implement power management specific tasks, e.g., to control voltage and/or frequency of various components of device 900, to control wake-up state, sleep state, and/or any other appropriate power state of various components of device 900, control battery power usage, charging of the battery 918, features related to power saving operation, etc.

In various embodiments, VR 914 includes—or alternatively, is coupled to—a charger circuit and a bypass circuit (not shown) which, for example, provide functionality of buck-boost converter 320 and bypass circuit 322, respectively. In one such embodiment, PCU 910b and/or other suitable power control circuitry of device 900 provides functionality—such as that of control logic 134—to detect for an opportunity to charge battery 918 while continuing to meet a power demand of load circuitry such as that of processor 904. Such power control circuitry further provides functionality—such as that of PD controller 124—to participate in communications with a programmable power adapter (not shown) which is to couple to device 900. In an embodiment, such communications are to configure an operational mode of the programmable power adapter—e.g., wherein a power delivery scheme to charge battery 918 includes the operational mode, and an activation state of the switch circuit.

Techniques and architectures for managing a delivery of power are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In the description herein, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In one or more first embodiments, a device comprises first circuitry to identify a state of charge of a battery during a delivery of power to a load circuit which is coupled to the battery, wherein the delivery of power is to be performed with a programmable power adapter, wherein a charger circuit is to be coupled between the programmable power adapter and the load circuit, and wherein bypass circuitry is to be coupled to selectively enable a bypass of the charger circuit, and perform an evaluation based on the state of charge and a test criteria, and second circuitry coupled to the first circuitry, the second circuitry to perform an identification of a scheme based on the evaluation, wherein the scheme comprises both an operational mode of the programmable power adapter, and an activation state of the bypass circuitry, and output one or more signals, based on the identification, to indicate that the bypass circuitry is to be in the activation state, and to transition the programmable power adapter to the operational mode.

In one or more second embodiments, further to the first embodiment, the device further comprises third circuitry coupled to the second circuitry, wherein, based on the one or more signals, the third circuitry is to participate in a communication with a power delivery controller of the programmable power adapter.

In one or more third embodiments, further to the second embodiment, the communication is according to a protocol which is compatible with a universal serial bus (USB) power delivery (PD) standard.

In one or more fourth embodiments, further to the second embodiment, the device further comprises a hardware interface to couple the device to the programmable power adapter via a cable assembly, the load circuit, the charger circuit, and the battery.

In one or more fifth embodiments, further to the second embodiment, the device further comprises a hardware interface to couple the device to the programmable power adapter via a cable assembly, and a transmission coil coupled to the hardware interface, the transmission coil to wirelessly deliver power to another device which comprises the load circuit, the charger circuit, and the battery.

In one or more sixth embodiments, further to the first embodiment or the second embodiment, the first circuitry is to perform a first evaluation to detect for a first condition wherein an amount of a charge of the battery is below a threshold while the load circuit is in a low power state, and wherein, based on a detection of the first condition, the second circuitry is to select a first scheme wherein, during a first operational mode of the programmable power adapter, the bypass circuitry is in a first activation state which provides the supply voltage to power the load circuit independent of the charger circuit, and wherein, in the first operational mode, the programmable power adapter is to prevent a change of a supply current.

In one or more seventh embodiments, further to the first embodiment or the second embodiment, the first circuitry is to perform a first evaluation to detect for a first condition wherein an amount of a charge of the battery is above a first threshold, and the programmable power adapter is able to support an estimated power demand by the load circuit, wherein, based on a detection of the first condition, the second circuitry is to select a first scheme wherein, during a first operational mode of the programmable power adapter, the bypass circuitry is in a first activation state which provides the supply voltage to power the load circuit independent of the charger circuit, wherein the first operational mode is to enable the programmable power adapter to vary a supply current, and wherein, in the first operational mode, the programmable power adapter is to prevent a change of a supply voltage.

In one or more eighth embodiments, further to the seventh embodiment, the first circuitry is to perform a second evaluation to detect for a second condition wherein the amount of the charge is above a second threshold and below the first threshold, wherein, based on a detection of the second condition, the second circuitry is to select a second scheme wherein, during a second operational mode of the programmable power adapter, the bypass circuitry is in a second activation state which provides the supply voltage to power the load circuit independent of the charger circuit, and which is to enable a boost charging of the battery by the charger circuit, and wherein, in the second operational mode, the programmable power adapter is to prevent a change of the supply voltage.

In one or more ninth embodiments, further to the eighth embodiment, the first circuitry is to perform a third evaluation to detect for a third condition wherein the amount of the charge is above a third threshold and below the second threshold, wherein, based on a detection of the third condition, the second circuitry is to select a third scheme wherein, during a third operational mode of the programmable power adapter, the bypass circuitry is in a third activation state which provides the supply voltage to power the load circuit independent of the charger circuit, and which is to enable a buck charging of the battery by the charger circuit, and wherein, in the third operational mode, the programmable power adapter is to prevent a change of the supply current.

In one or more tenth embodiments, a device comprises a buck-boost charger circuit to be coupled between a programmable power adapter and a load circuit, a switch circuit coupled to selectively enable a bypass of the buck-boost charger circuit, a monitor circuit to identify a state of charge of a battery during a delivery of power with the programmable power adapter while the battery is coupled to the load circuit, and perform an evaluation based on the state of charge and a test criteria, and a controller circuit coupled to the monitor circuit, the controller circuit to perform an identification of a power delivery scheme based on the evaluation, wherein the power delivery scheme comprises both an operational mode of the programmable power adapter, and an activation state of the bypass circuitry, and output one or more signals, based on the identification, to indicate that the bypass circuitry is to be in the activation state, and to transition the programmable power adapter to the operational mode.

In one or more eleventh embodiments, further to the tenth embodiment, the device further comprises a first power delivery controller coupled to the controller circuit, wherein, based on the one or more signals, the first power delivery controller is to participate in a communication with a second power delivery controller of the programmable power adapter.

In one or more twelfth embodiments, further to the eleventh embodiment, the communication is according to a protocol which is compatible with a universal serial bus (USB) power delivery (PD) standard.

In one or more thirteenth embodiments, further to the eleventh embodiment, the device further comprises a hardware interface to couple the device to the programmable power adapter via a cable assembly, the load circuit, the charger circuit, and the battery.

In one or more fourteenth embodiments, further to the eleventh embodiment, the device further comprises a hardware interface to couple the device to the programmable power adapter via a cable assembly, and a transmission coil coupled to the hardware interface, the transmission coil to wirelessly deliver power to another device which comprises the load circuit, the charger circuit, and the battery.

In one or more fifteenth embodiments, further to the tenth embodiment or the eleventh embodiment, the monitor circuit is to perform a first evaluation to detect for a first condition wherein an amount of a charge of the battery is below a threshold while the load circuit is in a low power state, and wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit, and wherein, in the first operational mode, the programmable power adapter is to prevent a change of a supply current.

In one or more sixteenth embodiments, further to any of the tenth embodiment or the eleventh embodiment, the monitor circuit is to perform a first evaluation to detect for a first condition wherein an amount of a charge of the battery is above a first threshold, and the programmable power adapter is able to support an estimated power demand by the load circuit, wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit, wherein the first operational mode is to enable the programmable power adapter to vary a supply current, and wherein, in the first operational mode, the programmable power adapter is to prevent a change of a supply voltage.

In one or more seventeenth embodiments, further to the sixteenth embodiment, the monitor circuit is to perform a second evaluation to detect for a second condition wherein the amount of the charge is above a second threshold and below the first threshold, wherein, based on a detection of the second condition, the controller circuit is to select a second power delivery scheme wherein, during a second operational mode of the programmable power adapter, the bypass circuitry is in a second activation state which provides the supply voltage to power the load circuit independent of the charger circuit, and which is to enable a boost charging of the battery by the charger circuit, and wherein, in the second operational mode, the programmable power adapter is to prevent a change of the supply voltage.

In one or more eighteenth embodiments, further to the seventeenth embodiment, the monitor circuit is to perform a third evaluation to detect for a third condition wherein the amount of the charge is above a third threshold and below the second threshold, wherein, based on a detection of the third condition, the controller circuit is to select a third power delivery scheme wherein, during a third operational mode of the programmable power adapter, the bypass circuitry is in a third activation state which provides the supply voltage to power the load circuit independent of the charger circuit, and which is to enable a buck charging of the battery by the charger circuit, and wherein, in the third operational mode, the programmable power adapter is to prevent a change of the supply current.

In one or more nineteenth embodiments, a system comprises an apparatus comprising a load circuit comprising a processor, a buck-boost charger circuit to be coupled between a programmable power adapter and the load circuit, a switch circuit coupled to selectively enable a bypass of the buck-boost charger circuit, a monitor circuit to identify a state of charge of a battery during a delivery of power with the programmable power adapter while the battery is coupled to the load circuit, and perform an evaluation based on the state of charge and a test criteria, and a controller circuit coupled to the monitor circuit, the controller circuit to perform an identification of a power delivery scheme based on the evaluation, wherein the power delivery scheme comprises both an operational mode of the programmable power adapter, and an activation state of the bypass circuitry, and output one or more signals, based on the identification, to indicate that the bypass circuitry is to be in the activation state, and to transition the programmable power adapter to the operational mode, and a display device coupled to the apparatus, the display device to display an image based on a computation by the processor.

In one or more twentieth embodiments, further to the nineteenth embodiment, the apparatus further comprises a first power delivery controller coupled to the controller circuit, wherein, based on the one or more signals, the first power delivery controller is to participate in a communication with a second power delivery controller of the programmable power adapter.

In one or more twenty-first embodiments, further to the twentieth embodiment, the communication is according to a protocol which is compatible with a universal serial bus (USB) power delivery (PD) standard.

In one or more twenty-second embodiments, further to the nineteenth embodiment or the twentieth embodiment, the monitor circuit is to perform a first evaluation to detect for a first condition wherein an amount of a charge of the battery is below a threshold while the load circuit is in a low power state, and wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit, and wherein, in the first operational mode, the programmable power adapter is to prevent a change of a supply current.

In one or more twenty-third embodiments, further to the nineteenth embodiment or the twentieth embodiment, the monitor circuit is to perform a first evaluation to detect for a first condition wherein an amount of a charge of the battery is above a first threshold, and the programmable power adapter is able to support an estimated power demand by the load circuit, wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit, wherein the first operational mode is to enable the programmable power adapter to vary a supply current, and wherein, in the first operational mode, the programmable power adapter is to prevent a change of a supply voltage.

In one or more twenty-fourth embodiments, further to the twenty-third embodiment, the monitor circuit is to perform a second evaluation to detect for a second condition wherein the amount of the charge is above a second threshold and below the first threshold, wherein, based on a detection of the second condition, the controller circuit is to select a second power delivery scheme wherein, during a second operational mode of the programmable power adapter, the bypass circuitry is in a second activation state which provides the supply voltage to power the load circuit independent of the charger circuit, and which is to enable a boost charging of the battery by the charger circuit, and wherein, in the second operational mode, the programmable power adapter is to prevent a change of the supply voltage.

In one or more twenty-fifth embodiments, further to the twenty-fourth embodiment, the monitor circuit is to perform a third evaluation to detect for a third condition wherein the amount of the charge is above a third threshold and below the second threshold, wherein, based on a detection of the third condition, the controller circuit is to select a third power delivery scheme wherein, during a third operational mode of the programmable power adapter, the bypass circuitry is in a third activation state which provides the supply voltage to power the load circuit independent of the charger circuit, and which is to enable a buck charging of the battery by the charger circuit, and wherein, in the third operational mode, the programmable power adapter is to prevent a change of the supply current.

In one or more twenty-sixth embodiments, a method comprises identifying a state of charge of a battery during a delivery of power to a load circuit which is coupled to the battery, wherein the delivery of power is performed with a programmable power adapter, wherein a charger circuit is coupled between the programmable power adapter and the load circuit, and wherein bypass circuitry is coupled to selectively enable a bypass of the charger circuit, performing an evaluation based on the state of charge and a test criteria, performing an identification of a scheme based on the evaluation, wherein the scheme comprises both an operational mode of the programmable power adapter, and an activation state of the bypass circuitry, based on the identification, signaling that the bypass circuitry is to be in the activation state, based on the identification, transitioning the programmable power adapter to the operational mode.

In one or more twenty-seventh embodiments, further to the twenty-sixth embodiment, the method further comprises participating in a communication with a power delivery controller of the programmable power adapter.

In one or more twenty-eighth embodiments, further to the twenty-seventh embodiment, the communication is according to a protocol which is compatible with a universal serial bus (USB) power delivery (PD) standard.

In one or more twenty-ninth embodiments, further to the twenty-sixth embodiment or the twenty-seventh embodiment, performing the evaluation comprises performing a first evaluation to detect for a first condition wherein an amount of a charge of the battery is below a threshold while the load circuit is in a low power state, where the first condition is detected, the performing the identification of the scheme comprises selecting a first scheme wherein, during a first operational mode of the programmable power adapter, the bypass circuitry is in a first activation state which provides the supply voltage to power the load circuit independent of the charger circuit, and in the first operational mode, the programmable power adapter is to prevent a change of a supply current.

In one or more thirtieth embodiments, further to the twenty-sixth embodiment or the twenty-seventh embodiment, performing the evaluation comprises performing a first evaluation to detect for a first condition wherein an amount of a charge of the battery is above a first threshold, and the programmable power adapter is able to support an estimated power demand by the load circuit, where the first condition is detected, the performing the identification of the scheme comprises selecting a first scheme wherein, during a first operational mode of the programmable power adapter, the bypass circuitry is in a first activation state which provides the supply voltage to power the load circuit independent of the charger circuit, the first operational mode is to enable the programmable power adapter to vary a supply current, and in the first operational mode, the programmable power adapter is to prevent a change of a supply voltage.

In one or more thirty-first embodiments, further to the thirtieth embodiment, performing the evaluation further comprises performing a second evaluation to detect for a second condition wherein the amount of the charge is above a second threshold and below the first threshold, where the second condition is detected, the performing the identification of the scheme comprises selecting a second scheme wherein, during a second operational mode of the programmable power adapter, the bypass circuitry is in a second activation state which provides the supply voltage to power the load circuit independent of the charger circuit, and which enables a boost charging of the battery by the charger circuit, and in the second operational mode, the programmable power adapter is to prevent a change of the supply voltage.

In one or more thirty-second embodiments, further to the thirty-first embodiment, performing the evaluation further comprises performing a third evaluation to detect for a third condition wherein the amount of the charge is above a third threshold and below the second threshold, where the third condition is detected, the performing the identification of the scheme comprises selecting a third scheme wherein, during a third operational mode of the programmable power adapter, the bypass circuitry is in a third activation state which provides the supply voltage to power the load circuit independent of the charger circuit, and which enables a buck charging of the battery by the charger circuit, and in the third operational mode, the programmable power adapter is to prevent a change of the supply current.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
first circuitry to:
identify a state of charge of a battery during a delivery of power to a load circuit which is coupled to the battery, wherein the delivery of power is to be performed with a programmable power adapter, wherein a charger circuit is to be coupled between the programmable power adapter and the load circuit, and wherein bypass circuitry is to be coupled to selectively enable a bypass of the charger circuit; and
perform an evaluation based on the state of charge and a test criteria; and
second circuitry coupled to the first circuitry, the second circuitry to:
perform an identification of a scheme based on the evaluation, wherein the scheme comprises both an operational mode of the programmable power adapter, and an activation state of the bypass circuitry; and
output one or more signals, based on the identification, to indicate that the bypass circuitry is to be in the activation state, and to transition the programmable power adapter to the operational mode.

2. The device of claim 1, further comprising:
third circuitry coupled to the second circuitry, wherein, based on the one or more signals, the third circuitry is to participate in a communication with a power delivery controller of the programmable power adapter.

3. The device of claim 2, wherein the communication is according to a protocol which is compatible with a universal serial bus (USB) power delivery (PD) standard.

4. The device of claim 2, further comprising:
a hardware interface to couple the device to the programmable power adapter via a cable assembly;
the load circuit;
the charger circuit; and
the battery.

5. The device of claim 2, further comprising:
a hardware interface to couple the device to the programmable power adapter via a cable assembly; and
a transmission coil coupled to the hardware interface, the transmission coil to wirelessly deliver power to another device which comprises the load circuit, the charger circuit, and the battery.

6. The device of claim 1, wherein the first circuitry is to perform a first evaluation to detect for a first condition wherein an amount of a charge of the battery is below a threshold while the load circuit is in a low power state; and
wherein, based on a detection of the first condition, the second circuitry is to select a first scheme wherein, during a first operational mode of the programmable power adapter, the bypass circuitry is in a first activation state which provides the supply voltage to power the load circuit independent of the charger circuit; and
wherein, in the first operational mode, the programmable power adapter is to prevent a change of a supply current.

7. The device of claim 1, wherein the first circuitry is to perform a first evaluation to detect for a first condition wherein:
an amount of a charge of the battery is above a first threshold; and
the programmable power adapter is able to support an estimated power demand by the load circuit;
wherein, based on a detection of the first condition, the second circuitry is to select a first scheme wherein, during a first operational mode of the programmable power adapter, the bypass circuitry is in a first activation state which provides the supply voltage to power the load circuit independent of the charger circuit;
wherein the first operational mode is to enable the programmable power adapter to vary a supply current; and
wherein, in the first operational mode, the programmable power adapter is to prevent a change of a supply voltage.

8. The device of claim 7, wherein the first circuitry is to perform a second evaluation to detect for a second condition wherein the amount of the charge is above a second threshold and below the first threshold;
wherein, based on a detection of the second condition, the second circuitry is to select a second scheme wherein, during a second operational mode of the programmable power adapter, the bypass circuitry is in a second activation state which provides the supply voltage to power the load circuit independent of the charger circuit, and which is to enable a boost charging of the battery by the charger circuit; and
wherein, in the second operational mode, the programmable power adapter is to prevent a change of the supply voltage.

9. The device of claim 8, wherein the first circuitry is to perform a third evaluation to detect for a third condition wherein the amount of the charge is above a third threshold and below the second threshold;
wherein, based on a detection of the third condition, the second circuitry is to select a third scheme wherein, during a third operational mode of the programmable power adapter, the bypass circuitry is in a third activation state which provides the supply voltage to power the load circuit independent of the charger circuit, and which is to enable a buck charging of the battery by the charger circuit; and
wherein, in the third operational mode, the programmable power adapter is to prevent a change of the supply current.

10. A device comprising:
a buck-boost charger circuit to be coupled between a programmable power adapter and a load circuit;
a switch circuit coupled to selectively enable a bypass of the buck-boost charger circuit;
a monitor circuit to:
identify a state of charge of a battery during a delivery of power with the programmable power adapter while the battery is coupled to the load circuit; and
perform an evaluation based on the state of charge and a test criteria; and
a controller circuit coupled to the monitor circuit, the controller circuit to:
perform an identification of a power delivery scheme based on the evaluation, wherein the power delivery scheme comprises both an operational mode of the programmable power adapter, and an activation state of the bypass circuitry; and
output one or more signals, based on the identification, to indicate that the bypass circuitry is to be in the activation state, and to transition the programmable power adapter to the operational mode.

11. The device of claim 10, further comprising:
a first power delivery controller coupled to the controller circuit, wherein, based on the one or more signals, the first power delivery controller is to participate in a communication with a second power delivery controller of the programmable power adapter.

12. The device of claim 11, wherein the communication is according to a protocol which is compatible with a universal serial bus (USB) power delivery (PD) standard.

13. The device of claim 11, further comprising:
a hardware interface to couple the device to the programmable power adapter via a cable assembly; and
a transmission coil coupled to the hardware interface, the transmission coil to wirelessly deliver power to another device which comprises the load circuit, the charger circuit, and the battery.

14. The device of claim 10, wherein the monitor circuit is to perform a first evaluation to detect for a first condition wherein an amount of a charge of the battery is below a threshold while the load circuit is in a low power state; and
wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit; and
wherein, in the first operational mode, the programmable power adapter is to prevent a change of a supply current.

15. The device of claim 10, wherein the monitor circuit is to perform a first evaluation to detect for a first condition wherein:
an amount of a charge of the battery is above a first threshold; and
the programmable power adapter is able to support an estimated power demand by the load circuit;
wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit;
wherein the first operational mode is to enable the programmable power adapter to vary a supply current; and
wherein, in the first operational mode, the programmable power adapter is to prevent a change of a supply voltage.

16. A system comprising:
an apparatus comprising:
a load circuit comprising a processor;
a buck-boost charger circuit to be coupled between a programmable power adapter and the load circuit;
a switch circuit coupled to selectively enable a bypass of the buck-boost charger circuit;
a monitor circuit to:
identify a state of charge of a battery during a delivery of power with the programmable power adapter while the battery is coupled to the load circuit; and
perform an evaluation based on the state of charge and a test criteria; and
a controller circuit coupled to the monitor circuit, the controller circuit to:
perform an identification of a power delivery scheme based on the evaluation, wherein the power delivery scheme comprises both an operational mode of the programmable power adapter, and an activation state of the bypass circuitry; and
output one or more signals, based on the identification, to indicate that the bypass circuitry is to be in the activation state, and to transition the programmable power adapter to the operational mode; and
a display device coupled to the apparatus, the display device to display an image based on a computation by the processor.

17. The system of claim 16, further comprising:
a first power delivery controller coupled to the controller circuit, wherein, based on the one or more signals, the first power delivery controller is to participate in a communication with a second power delivery controller of the programmable power adapter.

18. The system of claim 17, wherein the communication is according to a protocol which is compatible with a universal serial bus (USB) power delivery (PD) standard.

19. The system of claim 16, wherein the monitor circuit is to perform a first evaluation to detect for a first condition wherein an amount of a charge of the battery is below a threshold while the load circuit is in a low power state; and
wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit; and
wherein, in the first operational mode, the programmable power adapter is to prevent a change of a supply current.

20. The system of claim 16, wherein the monitor circuit is to perform a first evaluation to detect for a first condition wherein:
an amount of a charge of the battery is above a first threshold; and
the programmable power adapter is able to support an estimated power demand by the load circuit;
wherein, based on a detection of the first condition, the controller circuit is to select a first power delivery scheme wherein, during a first operational mode of the programmable power adapter, the bypass circuitry is in a first activation state which provides the supply voltage to power the load circuit independent of the charger circuit;
wherein the first operational mode is to enable the programmable power adapter to vary a supply current; and
wherein, in the first operational mode, the programmable power adapter is to prevent a change of a supply voltage.
